(19) United States
(12) Patent Application Publication
(10) Pub. No.: US 2017/0021566 A1
(43) Pub. Date: Jan. 26, 2017

(54) SYSTEMS AND METHODS FOR PRODUCING THREE-DIMENSIONAL OBJECTS

(71) Applicant: John F. Lund, Ogden, UT (US)

(72) Inventor: John F. Lund, Ogden, UT (US)

(21) Appl. No.: 15/218,446

(22) Filed: Jul. 25, 2016

Related U.S. Application Data
(60) Provisional application No. 62/195,846, filed on Jul. 23, 2015.

(51) Int. Cl. B29C 67/00; B29B 7/88; B33Y 70/00; B33Y 30/00; B33Y 50/02; B41J 2/14; B33Y 10/00

(52) U.S. Cl. CPC B29C 67/0085; B41J 2/1433; B29C 67/0066; B29C 67/0088; B29B 7/88; B33Y 10/00; B33Y 30/00; B33Y 50/02; B33Y 70/00; B29K 2105/0058

(57) ABSTRACT

Systems and methods for producing three-dimensional objects from liquid resins are described. The system may mix one or more source material resins with at least one light-curable catalyst(s) to produce a light-curable mixture. One or more of the source materials may include unique physical properties when cured. The various source material resins and the light-curable catalyst may mix within a mixing chamber disposed in a controllable print head. The embodiments of the system can extrude the light-curable mixture from a nozzle and may solidify the mixture by exposing it to a light source. Repeated mixture and extrusion of the light-curable mixture, potentially on top of previous extrusions, may produce a three-dimensional object.

### RELATED APPLICATIONS

This application claims the benefit under 35 U.S.C. §119(e) of U.S. Provisional Patent Application No. 62/195,846, titled “SYSTEMS AND METHODS FOR PRODUCING THREE-DIMENSIONAL OBJECTS,” filed Jul. 23, 2015, which is hereby incorporated by reference herein in its entirety.

### TECHNICAL FIELD

The present disclosure relates to systems and methods of producing three-dimensional objects. More particularly, this disclosure relates to systems and methods for printing three-dimensional objects with varying physical properties.

### SUMMARY

The present disclosure provides systems and methods for producing three-dimensional objects from liquid resins. The disclosed embodiments may mix one or more source material liquid resins in a mixing chamber to create a mixture that is extruded. The mixture may be created with source materials having desired characteristics for forming a 3D object having varying qualities (e.g., flexibility, color, conductivity). In some embodiments, the mixture may include (or be mixed with) a light-sensitive curing catalyst. The liquid resin source materials and light-sensitive curing catalyst may be mixed within a mixing chamber, producing a light-curable mixture. The disclosed embodiments may extrude the mixture from an extrusion nozzle disposed in a movable print head. The embodiments may expose a light-curable extrusion to a light source, and may cause the extrusion to cure and solidify. Additional extrusions may be placed or deposited upon previously cured extrusions to form a solid three-dimensional object having varying qualities or characteristics as desired.

### BRIEF DESCRIPTION OF THE DRAWINGS

Additional aspects and advantages will be apparent from the following detailed description of preferred embodiments, which proceeds with reference to the accompany drawings, in which:

FIG. 1 is a perspective view of a printing system, according to one embodiment of the present disclosure.

FIG. 2 is a front view of a removable mixing chamber and extrusion nozzle, according to one embodiment.

FIG. 3 is a perspective view of two mixing chambers partially disposed in a print head, according to one embodiment.

FIG. 4 is a front view of an extrusion nozzle removed from a print head, according to one embodiment.

FIG. 5A is a front view of a removable mixing chamber and a removable extrusion nozzle with the mixing chamber and the extrusion nozzle disposed in a print head, according to one embodiment.

FIG. 5B is a front view of the removable mixing chamber and removable extrusion nozzle of FIG. 5A, the extrusion nozzle removed from the print head.

FIG. 6 is a front view of a removable mixing chamber and extrusion nozzle, according to one embodiment.

FIG. 7A is a perspective view of an extrusion nozzle with multiple nozzle heads, according to one embodiment.

FIG. 7B is a top view of an extrusion nozzle with multiple nozzle heads.

FIG. 8 is a perspective view of a light source disposed in the print head, according to one embodiment.

FIG. 9A is a rear view of a printing system including several source material storage containers, according to one embodiment.

FIG. 9B is a side view of a source material storage container that is attached to a printing system, according to one embodiment.

FIG. 9C is a side view of a source material storage container that is disengaged from a printing system, according to one embodiment.

FIG. 10 is a perspective view of a syringe pump, according to one embodiment.

FIGS. 11A-11D depict a method of producing a three-dimensional object, according to one embodiment.

FIG. 12 illustrates an object printed using standard fused filament 3D printing techniques.

### DETAILED DESCRIPTION OF PREFERRED EMBODIMENTS

The present disclosure will be better understood from the detailed description provided below and from the drawings of various embodiments, methods, and examples herein. These specifics, however, are provided for explanatory purposes that help the various embodiments of the disclosure to be better understood. The invention should therefore not be limited by the described embodiments, methods, and examples, but by all embodiments and methods within the scope and spirit of the invention as claimed.

The present disclosure provides systems and methods for producing three-dimensional objects from liquid resins. The embodiments described herein may mix one or more source material resins with a light-sensitive curing catalyst (e.g., a catalyst activated by heat, UV, infrared, and/or, a self-activating curing catalyst not substantially requiring a light source to begin curing). In some embodiments, the source material(s) and light-sensitive curing catalyst may be mixed within a mixing chamber disposed in a movable print head.

Some embodiments of the printing system may include a movable print head with at least one mixing chamber, an extrusion nozzle, and a light source, each disposed in the movable print head. Some embodiments of the method may include controlling a motor system to control a position of the movable print head according to three-dimensions of motion. Certain embodiments of the printing system may include one or more motors, stepper motors, and/or linear actuators, configured to operate according to one or more specific instructions of a control module, and may control the position and the movement of the moveable print head.

Some embodiments of the printing system may communicate one or more liquid source materials, such as liquid resins and other source materials to produce a three dimensional object or portion thereof including one or more physical properties (e.g. color, rigidity, density, conductivity, resistivity, melting point, etc.) based on the types and amount of each source material included. The printing system may communicate a plurality of source materials to the movable print head. Each of the source materials of the plurality of source materials may include a determined physical property when cured. Some embodiments may control the amount of each source material of the plurality of mixed source materials to produce a three dimensional object, or a portion thereof, possessing one or more physical characteristics (e.g. color, rigidity, density, conductivity, resistivity, melting point, etc.), with the value of each physical characteristic proportional or otherwise based on the kinds and amounts of each source material included in the cured mixture.

The print head may communicate received liquid source materials to a mixing chamber to mix the received materials and form a mixture. Further, the printing system may extrude the mixture from an extrusion nozzle of the print head to form layers of material that build to form a 3D object.

In certain embodiments, in addition to the source materials, at least one light-sensitive curing catalyst may be provided to the movable print head to be mixed with the source material(s).

The print head may communicate received liquid source materials and/or light-sensitive curing catalysts to a mixing chamber, to mix the received materials and form a light-curable mixture. Further, the printing system may extrude the light-curable mixture from an extrusion nozzle of the print head. Certain embodiments may power the light source disposed in the print head as a mixture is extruded to radiate light toward the extruded light-curable mixture, causing the extruded light-curable mixture to cure and solidify.

A layer of mixture created in the mixing chamber may be extruded upon a previously solidified layer of mixture, or may be extruded at a rate and/or a position that may be different from the rate and/or the position of an earlier extrusion. Certain embodiments of the printing system may repeat this process several times, layering a cured and solidified extrusion on top of another cured extrusion according to one or more printing system instructions, to produce a three-dimensional object corresponding to the printing system instructions. The embodiments can provide differing types or levels of source materials to the mixing chamber at different times, such that each layer can have desired properties (e.g., flexibility/rigidity, resilience, conductivity, resistivity, color, density, melting point), which may vary or be different from adjacent layers. Moreover, print property may continuously vary within each layer as well as between layers. For example, each layer does not have to be a solid color, creating a striped effect, but can gradually vary to create a smooth, gradual transition of colors. Properties may vary within individual layers as needed.

The printing method according to one embodiment may include extruding a determined volume of light-curable mixture or other mixture of source materials at a determined rate, and at a determined position. Certain embodiments of the method may include exposing an extruded light-curable mixture to a light source, causing the mixture to cure and solidify. In some embodiments, additional mixture of source material(s) (and optional catalyst) may be extruded upon a previously solidified mixture or may be extruded at a rate and/or position that may be different from the rate and/or position of an earlier extrusion. This process may be repeated, layering one or more cured and solidified extrusions on top of another cured and solidified extrusion, producing a three-dimensional object. Specifically, the method may include extruding a light-curable mixture from an extrusion nozzle disposed in a movable print head, onto an object plane configured to receive an object as it is printed. Thus, in some embodiments of the method, produced objects may be formed upon the object plane.

Some embodiments of the method may include controlling a motor system to control a position of the print head and extrusion nozzle of the print head, according to three dimensions of motion. The method may include utilizing a control module (not shown) which may include one or more devices capable of instructing motors, stepper motors, linear actuators, pumps, lights, laser, heat lamps, and/or other suitable electronic or mechanical devices. A further method may include instructing the device(s) to operate according to one or more specific instructions of the method which may be based on a time and position of the print head.

The method may also include interpreting a three-dimensional CAD object file, which may be commonly used by other printing systems, or analyzing a three-dimensional object CAD file, dividing the object of the file into discrete cross-sectional areas with a determined width, possibly basing the width upon the embodiment of the method and the liquid materials of the method. The method may further include directing the various control components and print head to operate and/or producing a cross-sectional extrusion based upon the characteristics of the cross-sectional area produced by the control device. For example, the method can include moving a print head, pumping liquid material from one or more storage containers via one or more storage container pumps, mixing one or more source materials and/or one or more light-sensitive curing catalysts to form a light-curable mixture, extruding a light-curable mixture, powering a light source in a particular pattern and at specific times, and possibly basing all of the preceding operations on a three-dimensional CAD file.

Further, the method may include coupling a removable mixing chamber and a removable extrusion nozzle with a print head; communicating several liquid materials to the mixing chamber, causing the mixing chamber to receive one or more source materials (and optionally a light-sensitive curing catalyst) through one or more mixing chamber input ports; creating a light-curable mixture by mixing the one or more source materials and one or more light-sensitive curing catalysts within the mixing chamber; and extruding the light-curable mixture, or otherwise causing the mixture to exit the mixing chamber. Some embodiments of the method may include mixing a plurality of liquid source materials to produce a three dimensional object or portion thereof including one or more physical properties (e.g. color, rigidity, density, conductivity, resistivity, melting point, etc.) based on the types and amount of each source material included in the mixture of a plurality of liquid source materials.

The method may further include communicating the light-curable mixture to an extrusion nozzle, configured to extrude the mixture at a controlled rate, and with a determined extrusion volume. Certain embodiments of the method may include controlling the nozzle to position a nozzle head and nozzle apertures to extrude varying volumes of light-curable mixture with varying rates of extrusion based upon an extrusion head coupled with the mixing chamber. The method may also include selectively powering one or more light sources to cure an extruded light-curable mixture. For example, the method may include powering one or more light emitting diodes (LEDs) to cause an extruded mixture to harden and/or cure. In other embodiments of the method, a head lamp, laser, flood lighting, or self-activating catalyst configured to harden without a light source may cause an extruded mixture to harden.

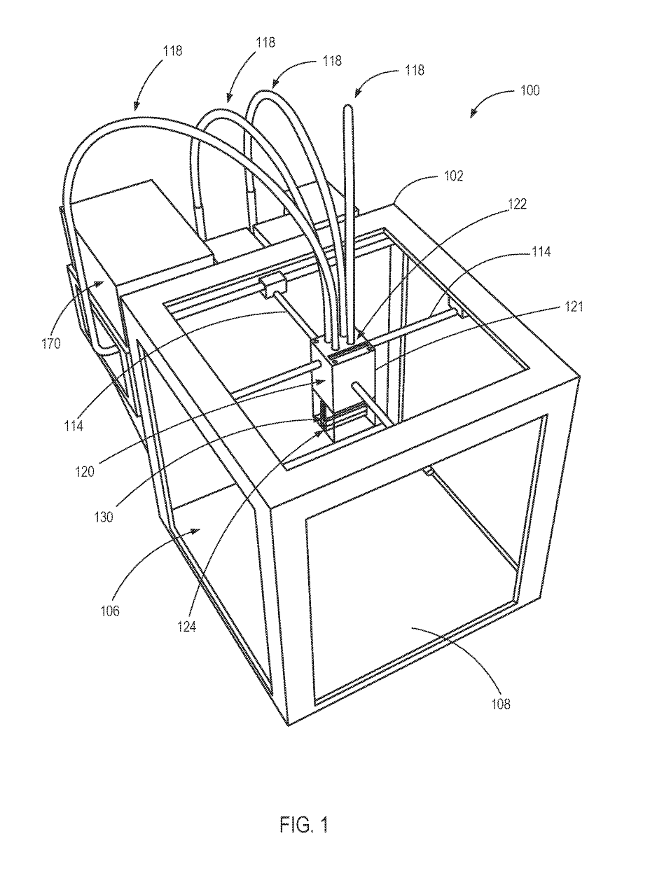

FIG. 1 is a perspective view of a printing system 100, according to one embodiment of the present disclosure. The printing system 100 may include a printer housing 102, a print head 120, one or more storage containers 170, and corresponding source material tubing 118.

The printer housing 102 may include a motor system and a control module (not shown). The printer housing 102 may be configured to house, secure, and/or receive several components of the printing system 100. The printer housing 102 may be configured to form an object plane 108 oriented parallel to the plane of motion of the print head 120. The object plane 108 may be configured to receive material as it is extruded from the print head 120. Objects produced by the printing system 100 may be formed upon the object plane 108.

The printer housing 102 may define a printing chamber or a printing space 106. In some embodiments, the object plane 108 may be disposed within an interior of the printing chamber 106 defined by the printer housing 102. In other embodiments, the object plane 108 may define a lower surface of the printing chamber 106. In some embodiments, the print head 120 may be configured to move in three dimensions of motion and may be limited to movement within the interior of the printing chamber 106. Consequently, in some embodiments three-dimensional objects produced by the printing system 100 may be produced within the interior of the printing chamber 106. In other embodiments, the range of motion of the print head 120 need not be restricted to the print chamber 106 defined by the printer housing 102.

The motor system of the printer housing 102 may be configured to alter the position of the print head 120 in three dimensions, referred to herein as the x, y, and z dimensions. The motor system may include a lateral motor system, a vertical motor system, and a motor control system. The lateral motor system may include two lateral motors and two corresponding lateral motor rails 114. The lateral motors may be configured to move the print head 120 along an x-y plane defined by the two lateral motor rails 114. In some embodiments, the x-y plane defined by the lateral motor rails 114 and the object plane 108 may be parallel to each other. The lateral motors may be configured to move the print head 120 to a determined x-y position at specific points along each of the two lateral motor rails 114. The two lateral motors may each mechanically couple with the print head 120 and with one of the two lateral motor rails 114 according to any suitable manner. For example, the lateral motors may couple with the print head 120 via chains, belts, and/or threaded screws. The lateral motors may cause the print head 120 to move in one direction by exerting a force on the print head 120 via the corresponding mechanical system. The motor control system may indicate to each of the lateral motors the respective x and y distances to move the print head 120. In some embodiments, the lateral motors may be disposed in the print head 120 rather than on the printer housing 102.

As can be appreciated, the vertical motor system may be configured in a manner similar to the lateral motor system. The vertical motor system may be configured to move the print head 120 a determined vertical distance in either an up or a down direction. The vertical motor system may elevate the print head 120 as each layer of a particular three-dimensional object is extruded. The vertical motor may couple with the lateral motor rails 114 or the print head 120 via a suitable mechanical system, such as chains, belts, or threaded screws. The lateral and vertical motor systems may be electronically coupled with the motor control system. The motor control system may set the position of the print head 120 in three dimensions (x, y, and z dimensions) at a particular time value, via the lateral and vertical motor systems. Thus, the motor control system may determine the position and the time corresponding to an extrusion of a light-curable mixture.

The control module (not shown) of the printing system 100 may include one or more suitable control devices. A suitable control device may include a device capable of instructing motors, stepper motors, linear actuators, pumps, lights, laser, heat lamps, and/or other suitable electronic or mechanical devices to operate in a specific way and in a specific time. A suitable control device may also be capable of interpreting three-dimensional CAD object files, which may be commonly used by other printing systems. A control device may analyze a three-dimensional object CAD file by slicing the object into discrete cross-sectional areas with a determined width, which may be based upon the configuration of the printing system 100. The printing system 100 may direct the various components to operate in a way which may produce a cross-sectional extrusion based upon the characteristics of the cross-sectional area produced by the control device. For example, the control device may instruct the print head 120 to move, storage container pumps to operate, and the print head 120 to extrude a mixture of source materials according to desire characteristics (color, rigidity, density, conductivity, resistivity, melting point, etc.) based on a three-dimensional CAD file. In certain embodiments, the mixture may include a light-sensitive catalyst and the control device may power a light source in a particular pattern and at specific times, based on a three-dimensional CAD file. Examples of suitable control devices may include a computer processor, a microprocessor, a field-programmable gate array (FPGA), a virtual machine, or any other suitable device for controlling operation of other elements of the printing system 100.

The print head 120 of the printing system 100 may include a print head body 121, a mixing chamber cartridge 130, and an extrusion nozzle. The print head body 121 may include several sockets to receive any removable components which may be housed within the print head 120. For example, the print head 120 may include a mixing chamber socket 124 shaped to receive the corresponding mixing chamber cartridge 130 of similar shape and/or configuration. The print head 120 may also include an extrusion nozzle socket, similarly shaped to receive an extrusion nozzle which may be removed or inserted into the print head 120. The print head 120 may include a sufficient amount of body material to secure the various removable components. The print head 120 may also be configured to house one or more stepper motors and/or linear actuators to control the movement of the print head 120. The print head 120 may also be configured to couple with one or more lateral motor rails 114 to enable the print head 120 to move in a plane of motion which is parallel to the object plane 108 defined by the printer housing 102. The lateral motor rails 114 may be a threaded rail system, belt, chain, or any other suitable system for mechanical control of the position of the print head 120. According to the previously described embodiments, the print head control system may couple with another control system to enable a control device to direct the motion of the print head 120 in three dimensions along with the other various motors and/or pumps which may be included in the printing system 100.

The mixing chamber cartridge 130 may be disposed in the movable print head 120 of the printing system 100. In some embodiments, the mixing chamber cartridge 130 may be configured to be removable from the print head 120. For example, the mixing chamber cartridge 130 may be configured to slide into and out of the mixing chamber socket 124 disposed in the print head 120. The mixing chamber cartridge 130 may be further configured to securely couple with one or more ports 122 disposed in the print head 120. The print head ports 122 may be configured to communicate liquid resin source material and/or a light-sensitive curing catalyst to a mixing chamber of the mixing chamber cartridge 130. Certain embodiments of the mixing chamber cartridge 130 may also be configured to create a significantly airtight seal between several mixing chamber ports and the various print head ports 122. The mixing chamber cartridge 130 may receive one or more source materials and a light-sensitive curing catalyst through several input ports disposed in a top surface of the mixing chamber cartridge 130. The source materials and light-sensitive curing catalyst may mix within a mixing chamber of the mixing chamber cartridge 130, creating a light-curable mixture, which may exit the mixing chamber cartridge 130 via an output port. The output port may be configured to couple with an extrusion nozzle (not shown in FIG. 1), and may create a secure seal between the mixing chamber cartridge 130 and the nozzle.

The extrusion nozzle may be referred to herein as the nozzle, or the print nozzle. However, it should be understood that extrusion nozzle, nozzle, and print nozzle may be used interchangeably herein with reference to the same component. The nozzle may include a nozzle body, a nozzle head, and an extrusion aperture. The nozzle may be configured to receive a light-curable mixture from the output port of the mixing chamber cartridge 130. The nozzle may be further configured to extrude the received light-curable mixture from a circular extrusion aperture disposed in a nozzle head. As can be appreciated, the nozzle may be configured to extrude the light-curable mixture at a determined rate, and with a determined size based upon the radius of the extrusion aperture. As can also be appreciated, the rate at which the nozzle head extrudes a light-curable mixture may be based on the radius of the extrusion aperture disposed in the nozzle head. In some embodiments, the nozzle may be configured to be removable from the print head 120. Additionally, the nozzle body may be configured to slide into a nozzle socket formed by the print head body 121. In some embodiments, the nozzle may include many nozzle heads disposed in a single nozzle body. Each nozzle head may include an extrusion aperture disposed in the tip of the nozzle head. In some embodiments, the printing system 100 may be configured to automatically switch between one or more nozzle heads to extrude a light-curable mixture at a rate based upon the chosen nozzle head and corresponding extrusion aperture.

Each of the storage containers 170 may be configured to contain a liquid resin or other source material (e.g., color/dye/ink, conductive material, etc.) or a light-sensitive curing catalyst. In some embodiments, one or more source material storage containers 170 may contain a source material which may cause a certain physical characteristic to be present in a cured extrusion when the extrusion includes the source material corresponding to the physical characteristic. For example, a first source material storage container 170 may contain a first liquid resin source material which may cause a determined rigidity in extruded and cured mixtures containing the first liquid resin source material. A second source material storage container 170 may contain a second liquid resin source material, which may cause a determined color, opacity, and/or pearlescence in extruded and cured mixtures containing the second liquid resin source material. In other embodiments, storage containers 170 may contain additional liquid resin source materials, which may cause other physical characteristics, such as conductivity, density, boiling point, melting point, and/or tensile strength, in cured extrusions which include those source materials.

For example, glitter may be added to a liquid resin source material mixture to achieve a desired appearance. Resins with varying color/opacity, etc. can be mixed to create varying physical properties within and between print layers. A resin containing powdered metal (such as aluminum, copper, etc.) could be mixed (within the mixing chamber of the mixing chamber cartridge 130, within the print nozzle, or within material conduits with a resin not containing powdered metal so that the electrical conductivity can be continuously varied within and between layers of a printed object. Another option would be to utilize additives such as microspheres to reduce weight and increase viscosity. Mixing resins containing microspheres in the mixing chamber cartridge 130, within the print nozzle, or within the material conduits with a resin not containing microspheres would allow for a print result of varying density both within and between printed layers. Both one and two-part resins can be used to print solid objects with this invention because the two-part resins could be mixed in a mixing chamber, within the print nozzle or conduit just prior to extrusion. There are a large number of chemistries that can be employed as UV curable resins—both one and two-part resins. There are resins from compatible chemistries that have highly variable shore hardnesses and elasticities. Resins from these chemistries can be mixed in a mixing chamber, within the print nozzle, or within the material conduit resulting in resins with intermediate properties.

The various liquid resin source materials may be configured to mix in the mixing chamber cartridge 130 prior to extrusion. Thus, the cured mixture may possess certain physical properties which may correspond to the amount of each of the various liquid resin source materials communicated to the mixing chamber cartridge 130 from a storage container 170, and included in the resulting extrusion.

The storage containers 170 may be coupled with the print head 120 via one or more pumping systems and liquid tubing 118. Each of the storage containers 170 may be configured to include an individual pump to communicate the source material or light-sensitive curing catalyst stored in one or more storage containers 170 to the print head 120. The storage containers 170 may be configured to pump the stored material into corresponding tubing 118 coupling the storage container 170 with the print head 120.

There are presently a large number of resins and adhesives that are UV-cured that can be extruded but cannot be used in stereo lithography systems because those systems require low viscosities. There is presently available a UV-cured silicone line that can have widely varying properties including electrical conductance and shore hardness. Products with differing physical characteristics can easily be mixed within a mixing chamber, within the print nozzle, or within the material conduit to form intermediate compounds. Additionally, they are 2-part systems that could be automatically mixed using this printer prior to dispensing and curing with UV light

Extrusion of gel, paste or clay-like resins is possible with the disclosed embodiments. These resins are not always UV-cured, but could be used to create objects that cannot be produced otherwise, such as self-supporting overhangs, etc.

The tubing 118 may be configured to couple the print head 120 with one or more storage containers 170 which may contain a liquid resin source material or a light-sensitive curing catalyst. The tubing 118 may place one or more storage containers 170 in fluid communication with the print head 120. Individual tubing 118 may be configured to couple a storage container 170 and an individual print head port 122. The tubing 118 may also be configured to create a secure seal between each ends of the tubing 118, a storage container 170, and the print head 120.

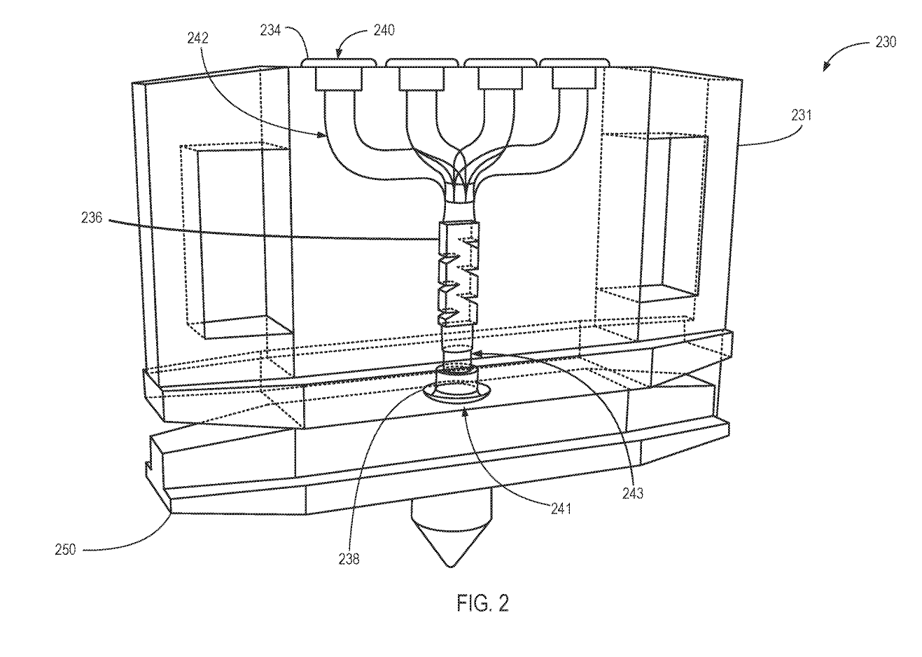

FIG. 2 is a mixing chamber 236 and an extrusion nozzle 250 according to one embodiment of a printing system that may resemble the printing system 100 described above in certain respects. Accordingly, like features are designated with like reference numerals, with the leading digits incremented to “2”. Relevant disclosures set forth above regarding similarly identified features thus may not be repeated hereafter. Moreover, specific features of the printing system may not be shown or identified by a reference numeral in the drawings or specifically discussed in the written description that follows. However, such features may be the same, or substantially the same, as features depicted in other embodiments and/or described with respect to such embodiments. Accordingly, the relevant descriptions of such features apply equally to the features of the printing system. Any suitable combination of the features and variations of the same described with respect to the printing system 100 can be employed with the printing system, and vice versa. Similarly, the printing system can be used with any suitable printing system housing, including the printer housing 102 discussed above. This pattern of disclosure applies equally to further embodiments depicted in subsequent figures and described hereafter, wherein the leading digits may be further incremented.

Specifically, FIG. 2 is a front view of a mixing chamber module 230 and an extrusion nozzle 250, according to one embodiment of the present disclosure. The mixing chamber module 230 may include a chamber body 231, one or more input ports 234, a mixing chamber 236, and at least one output port 238. The chamber body 231 may be configured to couple with a print head, and, in some embodiments, may be configured to enable the mixing chamber module 230 to easily couple with a print head. In some embodiments, the chamber body 231 may be configured to be polygonal in shape. Further, the chamber body 231 may include extended ridges disposed along the lower edges of the chamber body 231. The extended rectangular ridges may cause the lower portion of the chamber body 231 to be roughly T-shaped. In some embodiments, the extended ridges may be included along the top and bottom portions of the chamber body 231. The extended ridges may be shaped to couple with or be inserted into a corresponding track disposed in a print head. The ridges may couple with a track or path along which the chamber body 231 may travel when inserted into the print head and/or removed from the print head. As can be appreciated, the exact shape and/or orientation of the chamber body 231 and/or a corresponding track to receive the chamber body 231 disposed in a print head may be shaped and/or oriented according to any suitable configuration. Suitable configurations of the chamber body 231 and/or a print head may allow the mixing chamber module 230 to be inserted into and/or removed from the suitably configured print head, and may further enable the mixing chamber module 230 to be secured within the print head and/or automatically inserted, removed, and/or secured. Examples of other suitable configurations of the chamber body 231 may include a latch, a hook, a clamp, or any other suitable mechanism. In other embodiments, the mixing chamber module 230 may be configured to be automatically inserted into and/or removed from a print head by one or more stepper motors, linear actuators, or other suitable mechanical control system.

The chamber body 231 may be made of any sufficiently rigid material to maintain a determined shape after the chamber body 231 is initially formed. Further, suitable materials may enable the chamber body 231 to form relevant features of the mixing chamber module 230, such as several input ports 234, the mixing chamber 236 disposed in the interior of the chamber body 231, and at least one output port 238. A suitable material may also include sufficient tensile strength to withstand pressures applied on the mixing chamber module 230 during operation of the printing system. Suitable materials may also allow the mixing chamber module 230 to press against the print head when inserted, to facilitate an airtight seal between the various ports 234, 238 disposed in the mixing chamber module 230, and any corresponding ports disposed in the print head. In some embodiments, the chamber body 231 may be made of a material that is inexpensive and/or is configured to limit the cost of producing the mixing chamber module 230. For example, the chamber body 231 may be made of brass, nylon, polyethylene terephthalate (PET), high impact polystyrene (HIPS), acrylonitrile butadiene styrene (ABS), Polylactic acid (PLA), and/or ultra-high-molecular-weight polyethylene. In other embodiments, a mixing chamber module 230 to be used in the future to replace a current mixing chamber module 230 when it becomes clogged or otherwise requires replacement may be produced by the printing system.

The mixing chamber module 230 may be produced or stored on a spline, a roll, or any other suitable method to facilitate automatic replacement of a clogged mixing chamber with a new mixing chamber. In some embodiments, a motor may couple with the body of the mixing chamber to automatically control a mixing chamber replacement process. For example, the motor may insert a mixing chamber module 230 into an empty print head, secure a mixing chamber module 230 within a print head, and/or remove a mixing chamber module 230 from a print head. The mixing chamber control motor may be coupled with a control system of the printer housing. The control system may be configured to instruct the mixing chamber control motor when to change a mixing chamber module 230 in response to one or more sensors disposed in the mixing chamber module 230 to detect possible clogs. The control system may also instruct the mixing chamber control motor when to change the mixing chamber module 230 to prevent undesirable asynchronous activities between motors or pumps during production of a three-dimensional object. For example, the control system may instruct the mixing chamber control motor to replace a mixing chamber module 230 when material is not within, and/or being pumped to, the mixing chamber module 230. In other embodiments, the control system may instruct the mixing chamber control motor to replace a mixing chamber module 230 when no materials are being mixed within the mixing chamber module 230 to be replaced.

As mentioned previously, the mixing chamber module 230 may include one or more input ports 234. The input ports 234 of the mixing chamber module 230 may be configured to receive source materials from one or more source material storage containers, via corresponding source material tubing. One or more input ports 234 may be configured to receive a light-curable catalyst from a catalyst storage container and corresponding tubing. For example, a particular embodiment may include three input ports 234 each configured to receive a source material and may also include one input port 234 configured to receive a light-sensitive curing catalyst. However, in some embodiments of the mixing chamber module 230, an input port 234 configured to receive source material and an input port 234 configured to receive a light-sensitive curing catalyst may be configured identically to each other.

An input port 234 may include an input port aperture 240 and a corresponding port lumen 242. The input port aperture 240 may be a circular aperture that is disposed in an upper surface of the chamber body 231. The input port aperture 240 may be configured to couple with a port of a print head, and may receive a source material and/or a light-sensitive curing catalyst from the port of the print head. As can be appreciated, each input port aperture 240 may be shaped according to any suitable aperture shape. For example, an input port aperture 240 configured to receive one or more source materials and/or one or more light-curable catalysts may be shaped based on the source material and/or catalyst which the input port aperture 240 may be configured to receive.

In some embodiments, an input port aperture 240 may be configured to couple directly with source material tubing, and may receive source material directly from the coupled source material tubing. An input port aperture 240 of an input port 234 may be configured with a radius that is equal to the radius of another input port aperture 240. In other embodiments, an input port aperture 240 may include a radius that is different from one or more radii of another input port aperture 240. For example, the input port apertures 240 of input ports 234 that have been configured to receive a source material may each include equal aperture radii. But in some embodiments, the aperture radii of the input ports 234 configured to receive a source material may be configured to be a radius that is larger than the aperture radii of one or more input ports 234 that are configured to receive a light-sensitive curing catalyst. As may be appreciated, a nearly limitless number of additional suitable arrangements of input port radii may be considered. Further, the input ports 234, and thus the input port apertures 240, may each be disposed at points that are configured to be equidistant from the mixing chamber 236 configured to be in fluid communication with the input ports 234. In other embodiments, one or more input port apertures 240 may be disposed in the chamber body 231 at points that may vary in distance from the mixing chamber 236. Alternatively, the input port apertures 240 may be disposed at distances from the mixing chamber 236 according to a suitable grouping of the input port apertures 240, and may be so grouped and/or disposed based on a material which one or more of the input port apertures 240 may be configured to receive. Similarly to the radii of the input port apertures 240, a nearly limitless number of additional suitable configurations of the various distances between each of the input port apertures 240 and/or the mixing chamber 236 may be considered.

As mentioned previously, each input port apertures 240 may be configured to couple with a port disposed in the print head. In some embodiments, the input ports 234 may include components to facilitate an airtight connection between the input port apertures 240 and corresponding ports. The components to facilitate an uncompromised seal between the ports may include one or more O-rings, gaskets, washers, threading, and any other suitable securing and/or sealing mechanism. A suitable securing mechanism may exert a force on both the print head port and the input port 234, to cause the two to press together and compress any suitable sealing component such as an O-ring. In other embodiments, each of the input ports 234 and/or the input port apertures 240 may be configured to couple directly with tubing in place of a print head port. In some embodiments, the components to facilitate an uncompromised seal between the input ports 234 and tubing may be included in the tubing, or may be included in the input ports 234 as described previously.

An input port 234 may be configured to receive source material and/or light-curable catalyst from the port and/or tubing with which the input port 234 may be coupled with and/or with which the input port 234 may be configured to couple. Source material may be received by the input port aperture 240 and communicated to an input port lumen 242. An input port lumen 242 may be cylindrically shaped with a radius that may be equal to the radius of a corresponding input port aperture 240. In some embodiments, the radius of an input port lumen 242 may be configured to truncate or enlarge in any suitable region of the input port lumen 242. For example, the radius of an input port lumen 242 may decrease in a portion of the input port lumen 242 disposed distally from the input port aperture 240 of the input port 234. In other embodiments, the radius of an input port lumen 242 may increase in a portion of the input port lumen 242 disposed distally from a corresponding input port aperture 240. An input port lumen 242 may be disposed in the chamber body 231, and may be configured to communicate a source material and/or a light-sensitive curing catalyst to a mixing chamber 236. Thus, an input port lumen 242 may enable a fluid communication between a mixing chamber 236 and a corresponding input port 234. An input port lumen 242 may be configured by its shape, position, incline, and/or size to facilitate the communication of one or more source materials and/or one or more light-curable catalysts to a mixing chamber 236 coupled with the one or more input port lumens 242. Each of the input port lumens 242 may be configured in a manner that is substantially similar to, or different from, another input port lumen 242. For example, two or more input port lumens 242 may be configured to be significantly equal in shape, position, incline, and/or size. In other embodiments, one or more input port lumens 242 may be configured to be larger than at least one other input port lumen 242. In still other embodiments, some input port lumens 242 may be positioned to include a greater distance between the corresponding input port aperture 240 and the mixing chamber 236 than a similarly defined distance measured in other input port lumens 242 of the same embodiment. As can be appreciated, a nearly infinite number of different input port lumen 242 combinations may be considered. However, each of the input port lumens 242 may include any suitable configuration to enable a fluid communication between an input port 234 and a mixing chamber 236.

In some embodiments, an input port 234 may include a radio frequency device coupled with the input port 234 and configured to identify a proper source material port and/or a proper catalyst port configured to couple with the input port 234 of the radio frequency device. In other embodiments, a motor may be configured to control an input port aperture 240, and may be configured to automatically open and/or close the input port aperture 240 of an input port 234 based on an aperture control signal. An input port 234 may be further configured by its input port lumen 242 and/or input port aperture 240 to prevent or inhibit clogging of the input port 234. The input port 234 may be configured to prevent or inhibit clogging by the shape, incline and size of the input port aperture 240. Some embodiments of an input port 234 may include beveled, rounded, or any other suitably shaped portion(s) of the input port lumen 242 that may prevent or inhibit clogging of the input port 234.

Some embodiments of the mixing chamber 236 may receive and mix a plurality of liquid source materials. The mixing chamber 236 may output the mixture of the plurality of liquid source materials. The mixture may possess one or more desired physical properties based on the types and amounts of source materials received and mixed by the mixing chamber 236 and communicated to the output port 238. The output port 238 may communicate the mixture of the plurality of liquid source materials to an extrusion nozzle to extrude and cure the mixture, producing a three-dimensional object or portion thereof possessing one or more physical properties based on the types and amounts of source materials included in the mixture output by the output port 238.

For example, some embodiments may include mixing one or more colorants (e.g. dyes and/or pigments), or colored source materials, with a first source material that is translucent, clear, or white when cured. More specifically, some embodiments may include mixing one or more source materials or resins possessing a specific color (e.g. Cyan, Magenta, Yellow, Black, and/or, White) with a translucent source material, or a mixture of a translucent source material and one or more colored source materials. Mixing one or more colored source materials may enable the printing system to extrude mixtures of two or more source materials with a coloration of a plurality of possible colorations based on the color(s) of the source materials included in the mixture.

As another example, some embodiments may mix two or more source materials or resins each possessing a determined rigidity or flexibility when extruded and cured. Thus, by mixing at least two source materials, one source material being more flexible than the other source materials when cured, an extruded and cured mixture of the two source materials may include a determined rigidity or flexibility of a continuous range of possible flexibilities or rigidities of an extruded and cured mixture, based on the amount of rigid and/or flexible source material included in the mixture. Moreover, certain embodiments may include mixing a source material possessing a determined electric conductivity value or a resistive value to produce a three dimensional object or portion thereof with a determined resistance or conductance determined by the amount and kind of resistive or conductive source material included in the extruded and cured mixture of source materials. More generally, the printing system may produce cured extrusions with any suitable combination or value of physical properties based on the kinds and amounts of source materials included in the extruded mixture.

As can also be appreciated, in certain embodiments, a light-curing catalyst may be pre-mixed in certain materials where mixture in the mixing chamber may not provide a sufficiently homogenous mixture (such as highly viscous materials).

The mixing chamber 236 may be disposed within an interior of the chamber body 231, and may be disposed below one or more input ports 234 and may be disposed above at least one output port 238. The mixing chamber 236 may be a cavity or chamber configured to receive one or more liquid source materials and to receive one or more light-sensitive curing catalysts, to mix the received materials, and may be disposed in and/or formed by the chamber body 231. The mixing chamber 236 may be configured to receive at least one volume of one or more source materials and/or at least one volume of one or more light-curable catalysts from several input port lumens 242 configured to be in fluid communication with the mixing chamber 236. The mixing chamber 236 may be configured to cause the received source materials and/or the received light-curable catalyst(s) to mix in a controlled manner or at a determined rate of mixture. For example, the mixing chamber 236 may be configured to cause several received volumes of source material and a light-curable catalyst to mix for a determined amount of time while the various materials flow through the mixing chamber 236 possibly flowing toward an output port 238 of the mixing chamber module 230. The mixing chamber 236 may be further configured to mix the received substances to a determined mixture distribution of the one or more source materials and the one or more catalysts within the mixture. To facilitate mixing of the at least two received substances, the mixing chamber 236 may include an irregular flow path that is formed by a plurality of extended ridges. The received source materials as well as the received catalyst may be substantially mixed, or combined at a determined rate of composition as a result of flowing through the irregular flow channel of the mixing chamber 236. In some embodiments, the mixing chamber 236 may be oriented to cause any liquids received by the mixing chamber 236 to flow in a substantially downward direction, with abrupt alterations of the channel direction which may be oriented substantially orthogonal to the substantially downward direction of the flow channel. The resulting flow channel may be downward in direction overall, but may include alternating outward and inward deviations in the direction of the flow channel. The mixing chamber 236 is one embodiment configured according to several of the previously described conditions. As can be appreciated, other embodiments may incorporate differently shaped and/or oriented mixing chambers 236. Yet other embodiments may include more than one mixing chamber 236. For example, an embodiment may include an additional mixing chamber 236 disposed in an extrusion nozzle of the printing system. Still other embodiments may include at least two separate mixing chambers 236 disposed in a print head, each mixing chamber 236 configured to couple with a separate extrusion nozzle.

As mentioned above, the mixing chamber module 230 may include one or more output ports 238. Some embodiments of the mixing chamber module 230 may be configured to include only a single output port 238. Other embodiments may be configured to include two or more output ports 238 according to the configuration and quantity of mixing chambers 236 included in the embodiment. An output port 238 of a mixing chamber module 230 may include an output port lumen 243 in fluid communication with an output port aperture 241. An output port lumen 243 may be configured to receive a light-curable mixture from a mixing chamber 236 coupled with the output port lumen 243 and configured to be in fluid communication with the output port lumen 243. The output port lumen 243 may enable a fluid communication between a mixing chamber 236 and an output port aperture 241. The output port lumen 243 may be configured to receive a light-curable mixture from the mixing chamber 236, and may be further configured to communicate the light-curable mixture to the output port aperture 241. In some embodiments, an output port lumen 243 may be cylindrically shaped, with a radius based on an output port aperture 241 coupled with the output port lumen 243. In some embodiments, an output port lumen 243 may be configured to truncate and/or expand at one or more suitable regions of the output port lumen 243. For example, the radius of an output port lumen 243 may decrease or truncate in a region of the output port lumen 243 that is disposed distal to the output port aperture 241 of the output port 238 and disposed proximal to a mixing chamber 236. In other embodiments, the radius of an output port lumen 243 may increase or expand in a region of the output port lumen 243 that is disposed distal to the output port aperture 241 of the output port 238 and disposed proximal to a mixing chamber 236. An output port lumen 243 may be disposed in the chamber body 231, and may receive a light-curable mixture from the mixing chamber 236, and may be configured to communicate the light-curable mixture to the output port aperture 241. Thus, an output port lumen 243 may enable or facilitate a fluid communication between the mixing chamber 236 and an output port aperture 241 corresponding to the output port lumen 243.

As can be appreciated, an output port lumen 243 may also be configured by a shape, a position, an incline, and/or a size to facilitate a communication of a light-curable mixture from a mixing chamber 236 to an output port aperture 241. In those embodiments including at least two output ports 238, each output port lumen 243 may be configured according to any suitable configuration, specifically in relation to another output port lumen 243. In other embodiments, any output port lumen 243 may include any suitable configuration to enable a fluid communication between the mixing chamber 236 and a corresponding output port aperture 241.

The output port aperture 241 may be a circular aperture disposed in a lower surface of the chamber body 231. The output port aperture 241 may be configured to receive a light-curable mixture from the mixture chamber 236. As can be appreciated, the output port aperture 241 may be shaped according to any suitable aperture shape. For example, the output port aperture 241 may be shaped or otherwise configured to receive various light-curable mixtures based on the properties of the light-curable mixture which the output port aperture 241 may be configured to receive.

In some embodiments, the output port aperture 241 may be configured to couple with another print head port, and may communicate a light-curable mixture into a print head port. Some embodiments of the mixing chamber module 230 may include more than one output port 238. In such embodiments, the output port apertures 241 of each output port 238 may be configured to include equal radii, or in other embodiments, each output port 238 may include varying aperture radii.

As mentioned previously, the output port aperture 241 may be configured to couple with a port disposed in the print head, or may be configured to couple with an extrusion nozzle. In some embodiments, the output port 238 may include components to facilitate an airtight connection between the input apertures and corresponding ports. The components to facilitate an uncompromised seal between the ports may include one or more O-rings, washers, threading, and any other suitable securing and/or sealing mechanism. A suitable securing mechanism may exert a force on both the print head port or nozzle and the output port 238 or chamber body 231, to cause the two to press together and compress any suitable sealing component such as an O-ring. In other embodiments, the output port 238 and/or the output port aperture 241 may be configured to couple directly with a print head port in place of an extrusion nozzle. In some embodiments, the components to facilitate an uncompromised seal between the output ports 238 and/or nozzle may be included in the nozzle or print head port, or may be included in the output port 238 as described previously.

An output port 238 may be configured by its corresponding output port lumen 243 and/or output port aperture 241 to substantially prevent or inhibit clogging of the output port 238. The output port 238 may be configured to prevent or inhibit clogging by the shape, incline and size of the output port aperture 241. Some embodiments of an output port 238 may include beveled, rounded, or otherwise shaped portions of the output port aperture/lumen 241, 243 to inhibit port clogging or to inhibit the accumulation of blockage within the output port aperture 241.

In other embodiments of an output port 238, the output port 238 may be configured to engage and disengage a secure seal with an extrusion nozzle, when the nozzle is moved and/or replaced. As can be appreciated, causing the output port 238 to engage and disengage the extrusion nozzle to create a seal may be accomplished via motorized controls. Some embodiments may include automated output port controls, utilizing stepper motors to cause the output port 238 to engage and/or disengage an extrusion nozzle. In other embodiments of the mixing chamber module 230, the output port 238 may include automated output port aperture controls. The output port aperture 241 may be configured to open and close automatically in response to an automatic aperture motor control system. As can be appreciated, a motorized aperture control system may include one or more stepper motors, a motor control system, railed panels or sliding lids to close the output port aperture 241, and other suitable mechanisms.

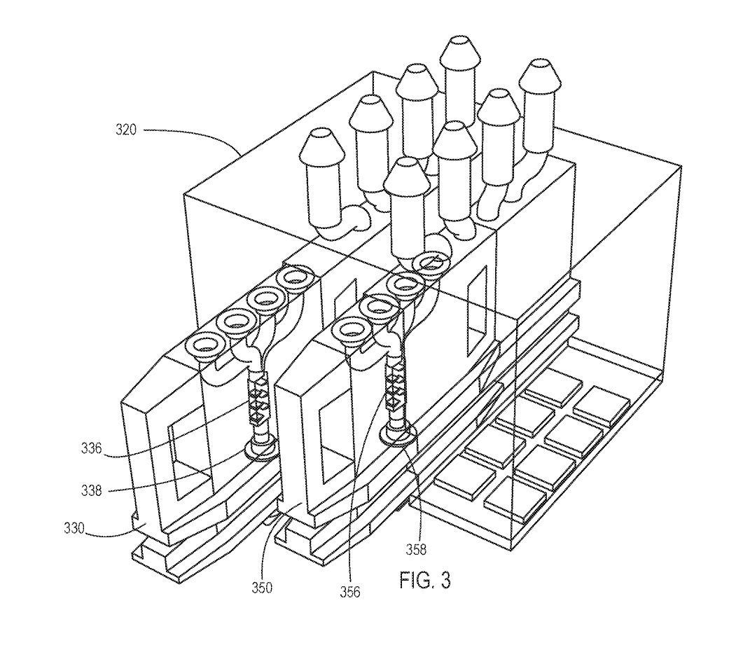

FIG. 3 is a perspective view of two mixing chambers 330, 350 configured to be disposed laterally adjacent to one another in a print head 320, according to one embodiment of the present disclosure. In certain embodiments, at least one source material, a light-sensitive curing catalyst and/or a mixture of either substance may require an amount of mixing time that may be specific to the substance to produce a certain light-curable mixture.

For example, a first portion of a light-curable mixture may require preliminary mixing and may again be mixed with another material following a suitable mixing time of the first portion of the light-curable mixture. Thus, a print head may be configured to include more than one mixing chamber in some embodiments of the printing system. Embodiments of the printing system may include a wide number of print heads 320 and mixing chambers 330, 350 as well as numerous configurations of a print head 320 and mixing chambers 330, 350.

Some embodiments of the printing system may include two mixing chambers 330, 350, with a first mixing chamber configured to output a light-curable mixture to a first extrusion nozzle, and may include a second mixing chamber configured to output a light-curable mixture to a second extrusion nozzle. The first and second mixing chambers 330, 350 may each be configured according to any suitable manner, and may each be configured differently from one another. In some embodiments, the mixing time of mixtures in each mixing chamber 330, 350 may be substantially similar to one another, or may vary considerably. In other embodiments, the volume of the two mixing chambers 330, 350 may be similar or substantially different. For example, the first mixing chamber 330 may be configured to substantially mix a determined volume of two liquid source materials in a first period of time. The second mixing chamber 350 may be configured to mix a volume of a third source material, a light-sensitive curing catalyst, and/or may be configured to output a light-curable mixture identical to the mixture output by the first mixing chamber 330. The second mixing chamber 350 may be configured to include a mixing chamber 356 with a greater volume than the volume of the first mixing chamber 330. However, other embodiments of the printing system may include any suitable configuration or number of mixing chambers.

In some embodiments, both mixing chambers 330, 350 may be configured to communicate a light-curable mixture to separate individual nozzle ports of two extrusion nozzles disposed in a single print head 320. The individual nozzle ports 338, 358 may each receive a light-curable mixture from the output aperture of a corresponding mixing chamber 336, 356. In some embodiments, each of the nozzle ports 338, 358 may be configured to couple with one another, and may mix the two light-curable mixtures to a greater or lesser extent, and may communicate the final light-curable mixture to a single extrusion nozzle. As can be appreciated, some embodiments of a print head 320 may include a nozzle port which may be configured to receive a light-curable mixture from one or more mixing chambers 330, 350 and may communicate the light-curable mixture to one or more extrusion nozzles.

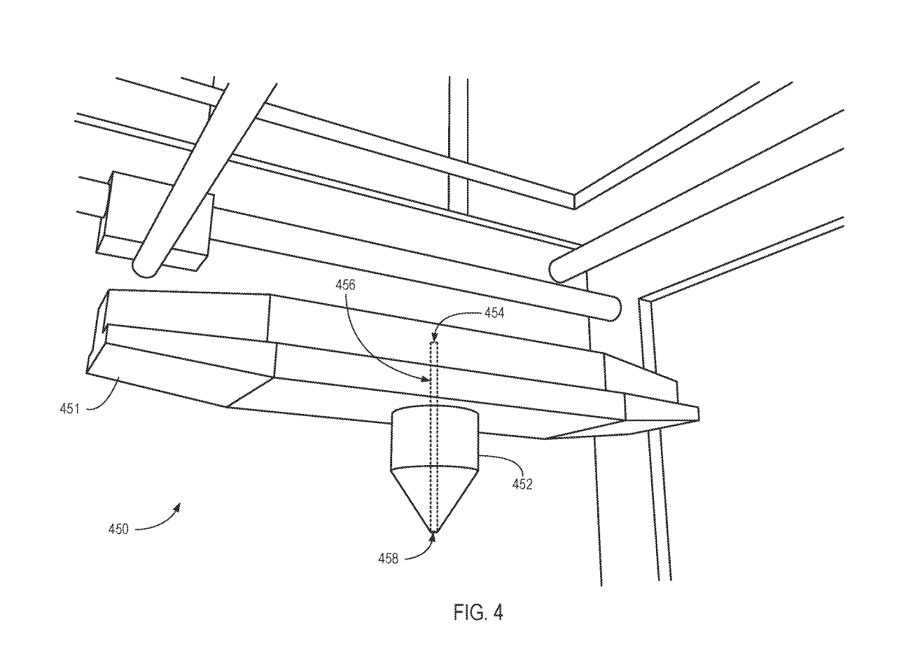

FIG. 4 is a front view of a detachable extrusion nozzle 450, according to one embodiment of the present disclosure. The extrusion nozzle 450 may include a nozzle body 451, an input nozzle aperture 454, a nozzle head 452, a nozzle lumen 456, and an extrusion aperture 458. The nozzle body 451 may be configured to easily couple with the print head of the printing system. In some embodiments, the nozzle body 451 may be configured to facilitate rapid insertion and/or removal of the nozzle 450 from the print head. The nozzle body 451 of a particular embodiment may be shaped according to any suitable configuration of that embodiment. In some embodiments, a suitable configuration of the nozzle body 451 may allow the nozzle 450 to slide into and out of a portion of the print head configured to receive the nozzle body 451. For example, a lower portion of the nozzle body 451 may be shaped similarly to the lower portion of a mixing chamber as described above for some embodiments. In these and possibly other embodiments, a lower portion of the nozzle body 451 may include rectangular extensions, roughly orthogonal to the lateral surfaces of the nozzle body 451. The lower portion of the nozzle body 451 may be roughly T-shaped, and may be shaped to couple with corresponding extensions disposed in a print head. The nozzle body 451 may be made of any sufficiently rigid material. However, many embodiments of the extrusion nozzle 450 may include the nozzle body 451 made of inexpensive plastics and/or polymers. For example, the nozzle body 451 may be made of brass, nylon, polyethylene terephthalate (PET), high impact polystyrene (HIPS), acrylonitrile butadiene styrene (ABS), Polylactic acid (PLA), and/or ultra-high-molecular-weight polyethylene. In some embodiments of the printing system, the nozzle 450 may be of one or more materials which may be extruded from the printing system. In these embodiments, the printing system may produce replacement nozzles which may replace clogged, damaged, or otherwise inoperable extrusion nozzles.

The input nozzle aperture 454 may be disposed in an upper surface of the nozzle body 451, and may be configured to couple with an output port of a mixing chamber. The input nozzle aperture 454 may be configured to define an input port of the nozzle 450. In other embodiments, the input nozzle aperture 454 may be included and/or defined by an input port of the nozzle 450. An input port of the nozzle 450 may include one or more O-rings, plastic washers, or other mechanisms to facilitate a secure seal between an output port of a mixing chamber and an input nozzle aperture 454 of the nozzle 450. In some embodiments, the input nozzle aperture 454 may be sized or shaped to couple with a specific mixing chamber output port. An input nozzle aperture 454 may be coupled with a corresponding nozzle lumen 456. The nozzle lumen 456 may in turn couple with the extrusion aperture 458 of the nozzle head 452. An input nozzle aperture 454 of a nozzle 450 may be configured to receive a light-curable mixture and may communicate a received light-curable mixture to a nozzle lumen 456, disposed in a nozzle head 452.

The nozzle head 452 may be disposed in the nozzle body 451, and may be configured to extend orthogonally away from a lower surface of the nozzle body 451. The nozzle head 452 may be generally cylindrical in shape, and may truncate toward a lower end, forming a cone and/or a tip of the nozzle head 452. The extrusion aperture 458 may be disposed in the tip of the nozzle head 452. The nozzle head 452 may also be configured to direct the flow of a light-curable mixture that may enter the nozzle 450 via the input nozzle aperture 454, to flow through the nozzle lumen 456, and may direct the light-curable mixture to exit the nozzle 450 from the extrusion aperture 458 disposed in the tip of the nozzle head 452.

A nozzle lumen 456 disposed in a nozzle head 452 may be cylindrically shaped, and may be configured with radii based on the radii of an input nozzle aperture 454 and an extrusion aperture 458 corresponding to the nozzle lumen 456. As can be appreciated, a nozzle lumen 456 may be shaped according to any suitable configuration. For example, the nozzle lumen 456 may include a funnel shape, a mixing chamber, a cylinder following a spiral path, and/or any other suitable shape. In some embodiments, the radii of the input nozzle and extrusion apertures 454, 458 may differ, causing the nozzle lumen 456 to truncate or expand at points closer to the input nozzle and extrusion apertures 454, 458. As mentioned previously, a nozzle lumen 456 may be disposed in or formed by a corresponding nozzle head 452. The length of a nozzle lumen 456 may be based on the length of a nozzle head 452 corresponding to the nozzle lumen 456. The nozzle lumen 456 may be configured to communicate a light-curable mixture received by the nozzle 450 via the input nozzle aperture 454, to the extrusion aperture 458 at a determined flow rate. The flow rate of a nozzle lumen 456 may be based upon the radius, length, and/or shape of the nozzle lumen 456.

A nozzle 450 may include an extrusion aperture 458 corresponding to each individual nozzle head 452. An extrusion aperture 458 may be disposed in the tip of a nozzle head 452, and may couple with a nozzle lumen 456 disposed in the nozzle head 452. Further, a nozzle 450 may be configured to extrude a light-curable mixture communicated to the extrusion aperture 458 from one or more nozzle lumens 456. An extrusion aperture 458 may be sized to facilitate extrusion of a determined volume of a light-curable mixture. For example, certain nozzles 450 may include an extrusion aperture 458 with a radius based upon the smallest desired extrusion size. Further, a nozzle 450 may include an extrusion aperture 458 with a radius configured to facilitate production of large and/or structural features of an object to be produced by the printing system. In such embodiments, the extrusion aperture 458 may be configured to extrude a volume of light-curable mixture corresponding to the large and/or structural features of the object.

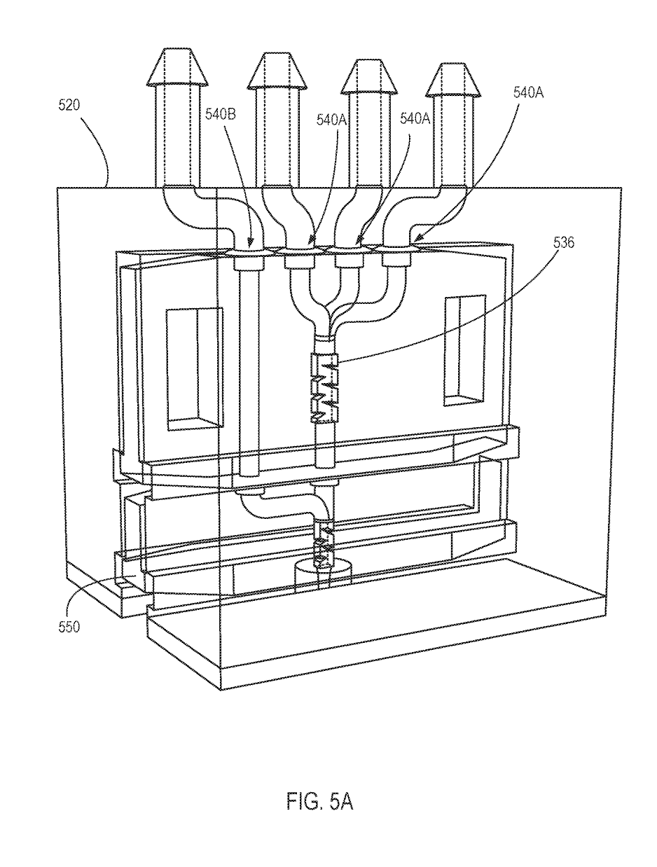

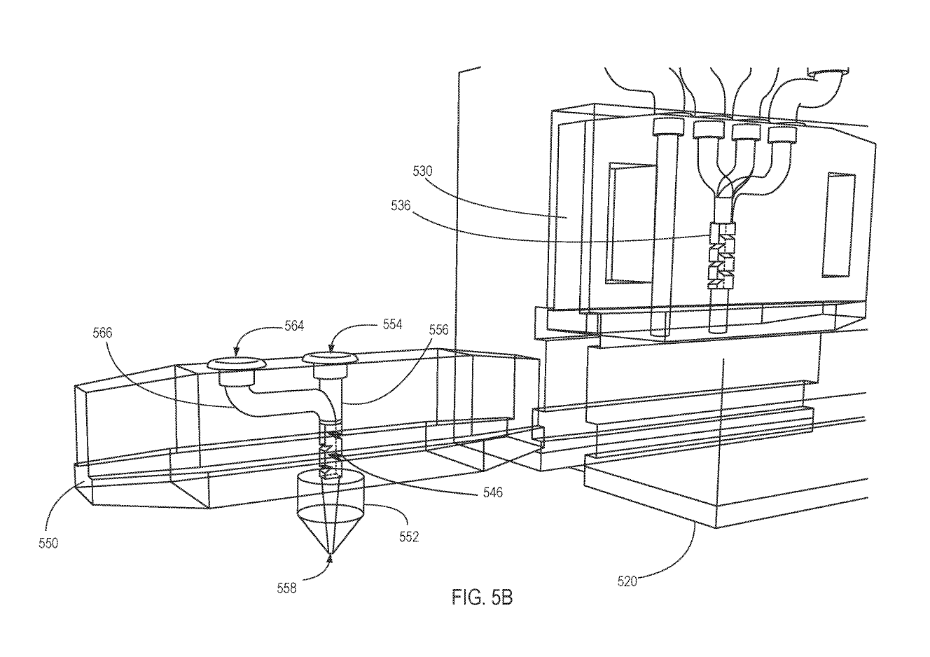

FIGS. 5A and 5B are perspective views of a mixing chamber 530 and an extrusion nozzle 550, according to one embodiment of the present disclosure. In some embodiments, to produce a certain light-curable mixture it may be necessary to form an initial mixture of two or more materials and to add additional materials to the initial mixture after the initial mixture is produced. Thus, some embodiments may include one or more mixing ports with individual ports coupling with a mixing chamber 536 at different points along the mixing chamber 536. The mixing chamber 530 may include a first grouping of input ports 540A for liquid resin source material or a light-sensitive curing catalyst, the input ports 540A coupling with the mixing chamber 536, and may include a second input port 540B, or second input port grouping 540B, configured to couple with a second mixing chamber 546 at a point below the first input port grouping 540A and the first mixing chamber 536. Two liquid resin source materials, a liquid resin source material, and/or one or more light-sensitive curing catalyst, or any suitable combination of these, may be received by the first input port grouping 540A. The materials received by the first input port grouping 540A may be communicated to the first mixing chamber 536, and begin to mix at a rate based upon the configuration of the first mixing chamber 536. Additional material, such as another liquid resin source material, light-sensitive curing catalyst, or mixture of one or more source materials and/or one or more catalysts may be input to the second input port grouping 540B. The second input port grouping 540B may communicate the added material to the initial mixture output by the first mixing chamber 536 after the material of the first input port grouping 540A has begun to mix in the first mixing chamber 536. In some embodiments, the additional material may be added to the initial mixture while the initial mixture is still flowing through the first mixing chamber 536, or may be added after the initial mixture has been output by the first mixing chamber 536. As can be appreciated, additional mixing chambers 546 and/or flow channels may be utilized to combine a more complex combination and/or number of liquid resin source materials and/or light-sensitive curing catalysts.

The first mixing chamber 536 may be configured to be removable from a print head 520, and may include other components and/or configurations similar to embodiments of the first mixing chamber 536 described previously. The first mixing chamber 536 may be further configured to be in fluid communication with the second mixing chamber 546 that is disposed in the removable extrusion nozzle 550. Similarly to the first mixing chamber 536, the removable extrusion nozzle 550 may be an extrusion nozzle 550 of the embodiments of an extrusion nozzle 550 described herein.

For example, the extrusion nozzle 550 may include a nozzle head 552, the nozzle head 552 forming an extrusion aperture 558, a plurality of input ports 554, 564, the plurality of input ports 554, 564 coupled with corresponding port lumens 556, 566, to place the plurality of ports 554, 564, in fluid communication with the second mixing chamber 546.

The extrusion nozzle 550 may also include any components and/or configuration described for other embodiments of the mixing chamber 530. The first mixing chamber 536 may be configured to couple with the extrusion nozzle 550 to facilitate a secure seal between the respective ports of the first mixing chamber 536 and the extrusion nozzle 550.

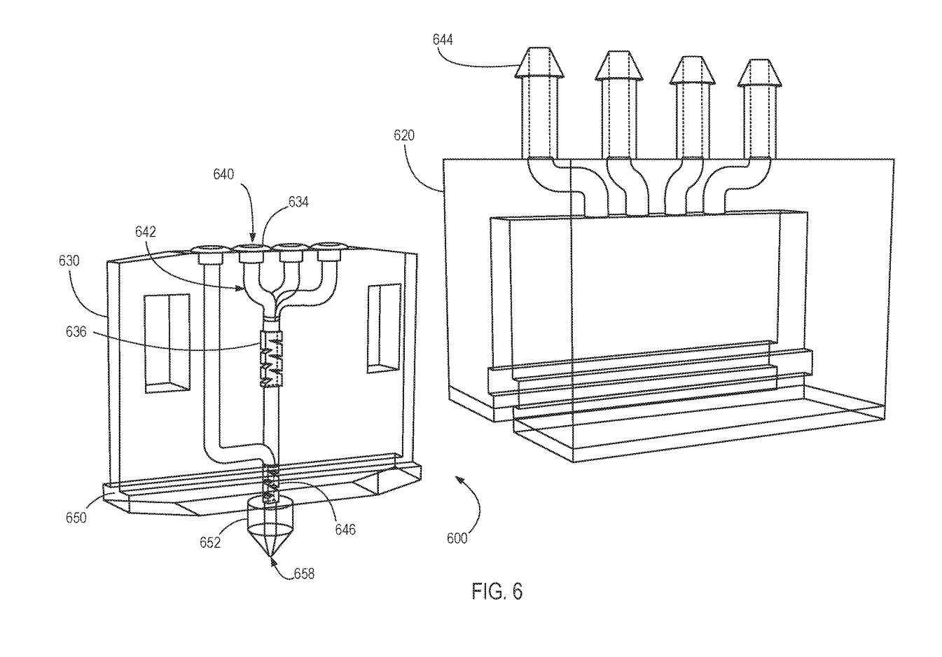

FIG. 6 is a front view of a removable mixing chamber 630 and extrusion nozzle 650, according to one embodiment of the present disclosure. The mixing chamber 630 and extrusion nozzle 650 may each be configured similarly to the embodiments described for FIG. 5. For example, the mixing chamber 630 and extrusion nozzle 650 may be configured to couple with a print head 620. The mixing chamber may include at least one input port 634 defining an input port aperture 640 and coupled with a corresponding input port lumen 642. The at least one input port 634 may place an input port 644 of the print head 620, in fluid communication with the mixing chamber

Some embodiments of the removable mixing chamber 630 and extrusion nozzle 650 may each be configured to be a portion of a single module 600. In such embodiments, a single module body may define a first mixing chamber 636 and a second mixing chamber 646, with the second mixing chamber 646 disposed in the extrusion nozzle 650. Thus, the first and second mixing chambers 636, 646, the extrusion nozzle 650 with a nozzle head 652 of the extrusion nozzle 650, the nozzle head defining an extrusion aperture 658 may be collectively defined by the single module 600.

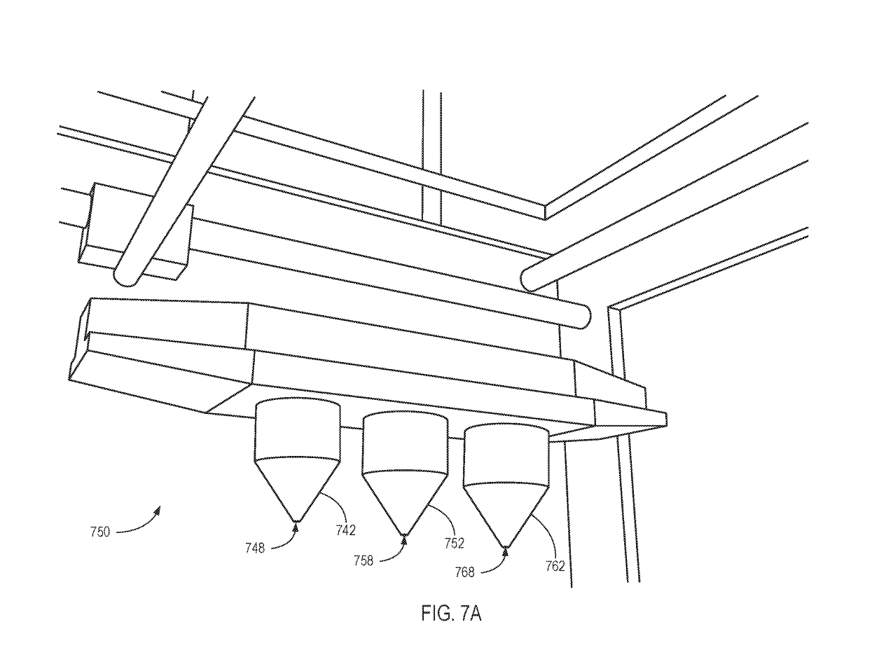

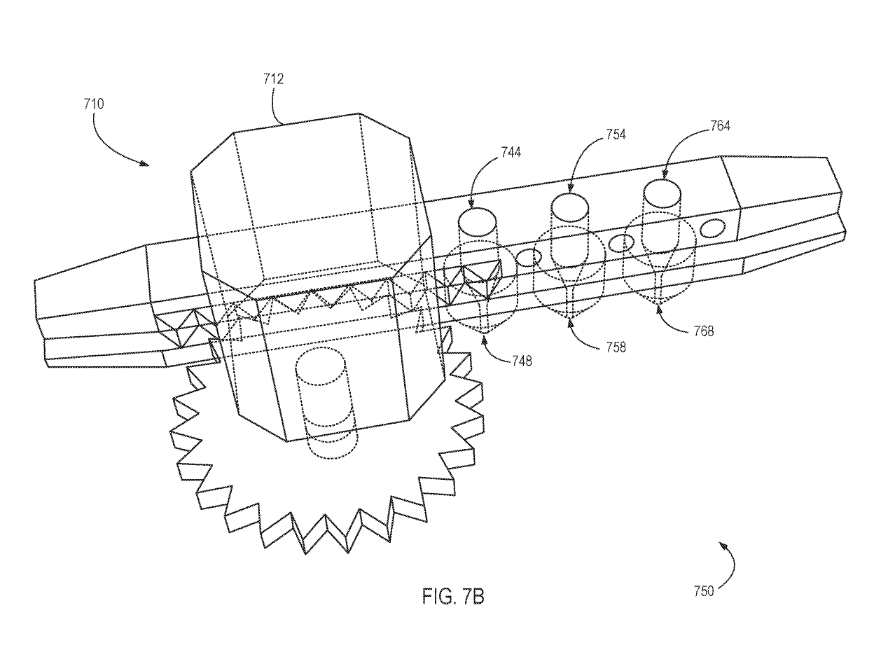

FIGS. 7A and 7B are perspective views of an extrusion nozzle 750 with multiple nozzle heads 742, 752, 762 according to one embodiment. In some embodiments, the printing system may be configured to automatically utilize several nozzle heads 742, 752, 762 of varying diameters. The extrusion nozzle 750 may include the same components as previously described, such as input apertures 744, 754, 764, corresponding to each of the nozzle heads 742, 752, 762. As can be appreciated, each extrusion aperture 748, 758, 768 may include a particular aperture radius based upon the desired extrusion size of the nozzle head 742, 752, 762. Further, the radius of an extrusion aperture 748 may be different from another extrusion aperture 758, or the radius of an extrusion aperture 748 may be similar to another extrusion aperture 758. Certain embodiments of the printing system may include a nozzle control system 710 with a nozzle stepper motor 712. The nozzle control system 710 may be configured to move the extrusion nozzle 750 laterally in either direction, to bring an individual nozzle head 742, 752, 762 and the corresponding input aperture into fluid communication with a mixing chamber. The nozzle head and input aperture brought into fluid communication with a mixing chamber may be based upon the desired extrusion size and the size of the extrusion aperture corresponding to the nozzle head in fluid communication with the mixing chamber.

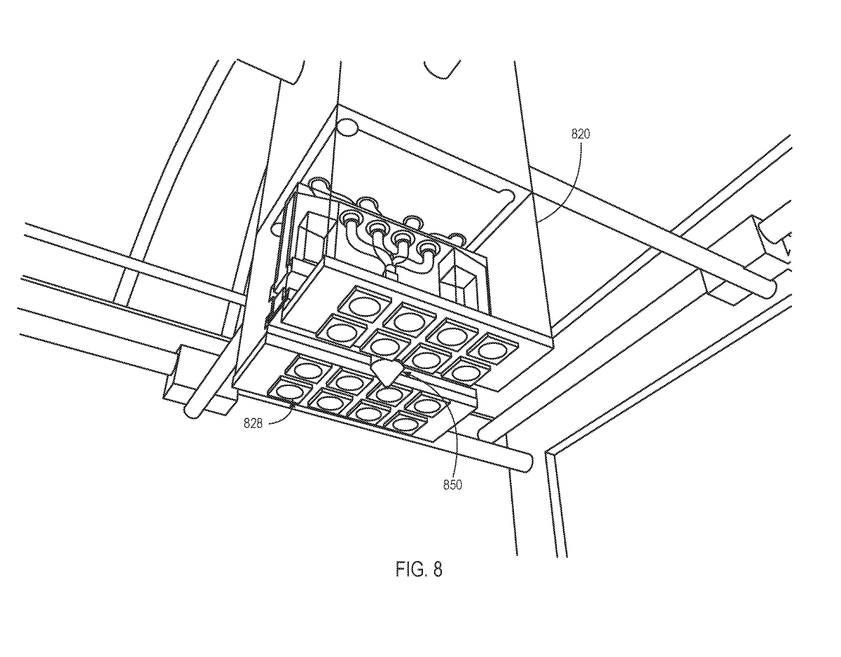

FIG. 8 is a perspective view of a light source disposed in a print head 820, according to one embodiment of the present disclosure. The light source may be disposed in a lower surface of the print head 820, and oriented downwards toward a printing plane. In some embodiments, the light source may include one or more light emitting diodes (LEDs) 828 that are disposed in a lower surface of the print head 820. The LEDs 828 may be substantially grouped or disposed adjacent to an extrusion nozzle 850 of the print head 820. Further, the LEDs 828 (or other suitable light source) may be configured to illuminate a determined region of a printing chamber and may be configured to radiate light toward an extruded light-curable mixture or toward a light-curable mixture while it is extruded. The printing system may include a light source control system capable of controlling each LED 828 individually or may be configured to control all LEDs 828 collectively. Thus, the printing system may cause individual LEDs 828 to radiate light toward a particular portion or feature of a printed object or light-curable extrusion without powering LEDs 828 which may radiate light in other directions or on other portions of an extruded light-curable mixture.

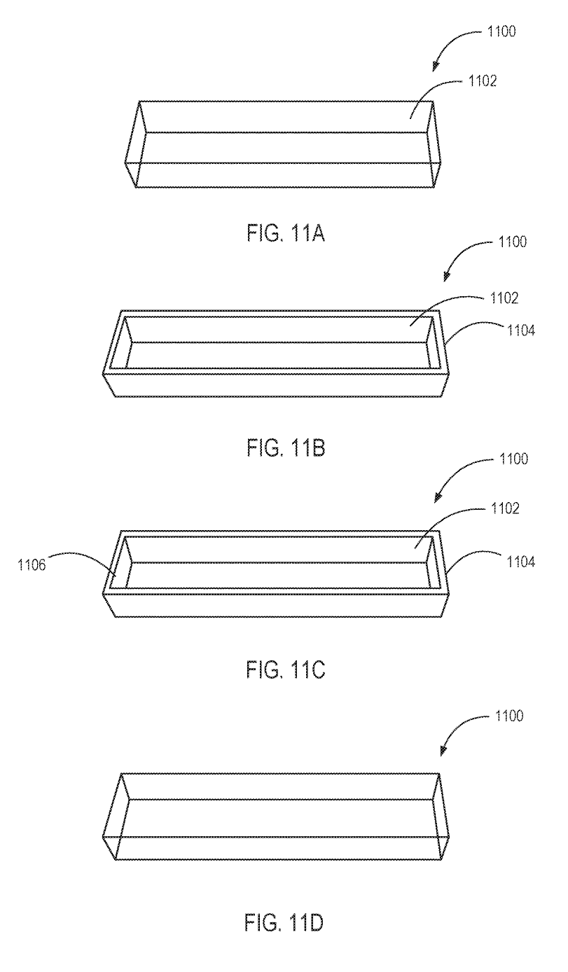

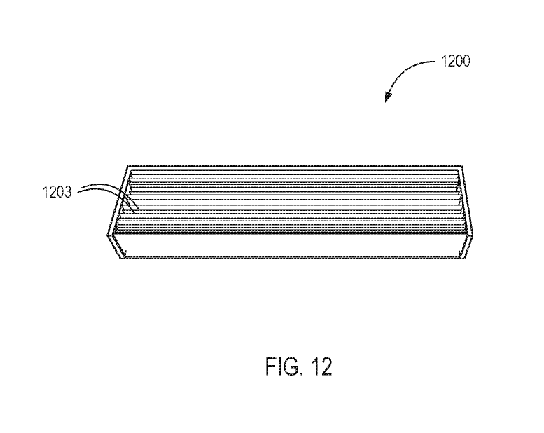

Optionally, the LEDs 828 can be turned on and off (either all or some) to allow for selectively delayed curing of resin. Selectively delayed curing can provide advantages over other presently available forms of extrusion 3D printing, in which the materials generally harden (e.g., are cured) immediately after being extruded. Selectively delayed curing can be used, for example, to allow for immediate curing of the outer walls of a thin portion of a transparent print, while later allowing thin resin to be flowed into space(s) between the walls, completely filling the region and eliminating the voids caused by immediate hardening of the extruded material. In this manner, transparent segments of prints can be created to be more completely transparent (see FIGS. 11A-11D). Standard fused filament 3D printing techniques leave small voids and interfaces between filaments resulting in internal reflection and refraction and therefore lack of true transparency (see FIG. 12). LED brightness can be controlled depending on the material being used so that it cures at the proper rate. This can be achieved via electronic circuitry (pulse width modulation (PWM) or similar) which can be controlled via software.

In other embodiments, the light source may include one or more lasers, directed to radiate light toward the extrusion nozzle 850 of the printing system. In some embodiments, the laser may be configured to radiate light directly at the extrusion nozzle 850 or extrusion aperture of the extrusion nozzle 850. The laser may be disposed in the print head 820, and may specifically be disposed adjacent to the extrusion nozzle 850. In some embodiments, the laser may utilize one or more lenses and/or mirrors to control the size, intensity, and/or path of the beam of light produced by the laser. For example, the laser may be disposed at some point other than the print head 820, such as in the printer housing. The laser may utilize one or more directive mirrors to direct the laser beam path toward the extrusion nozzle 850 of the print head 820. As can be appreciated, the printing system may also include one or more lenses, configured to control the width and intensity of the laser light. Certain embodiments of the printing system may include lenses and/or mirrors which are capable of rotation as well as movement to facilitate controlling the path of laser light as the print head 820 moves in three dimensions. The lenses and/or mirrors may also be configured to rotate/move automatically in response to a stepper motor or actuator coupled with a light-source control system. Thus, the printing system may include sufficient control of a laser light source to enable the printing system to direct the laser to radiate light to a light-curable extrusion.

In still other embodiments of the printing system, a curing catalyst may become active or begin curing when exposed to a significant amount of heat. The printing system may include a heat lamp, a hot air blower, a heating filament, and/or any suitable heating element to cause a heat-sensitive curing catalyst to cure. The heating element(s) may be disposed in the print head 820 adjacent to the extrusion nozzle 850, or may also be disposed in some other portion of the printing system. The heating element may be configured to direct heat on a heat-curable mixture prior to extrusion, as the mixture is extruded, or following extrusion of the mixture. The heating element may be configured to radiate heat toward the extrusion by blowing hot air toward the extrusion, being in physical contact with the extrusion (such as in the case of a heating plate disposed in the extrusion nozzle 850), or by any other suitable heating process. A cooling system may be used to cool the print nozzle, such as a chilled fluid or an electric cooling plate in physical contact with the nozzle

In yet other embodiments of the printing system, a catalyst may be used which does not require an activating energy source such as light or heat. In such embodiments, the source material and curing catalyst may be mixed immediately prior to extrusion and may cause the mixture to cure at a determined rate. For example, the source and curing catalyst mixture may be configured to cure immediately prior to extrusion, to cure as the mixture is extruded, or to cure immediately following extrusion of the mixture.

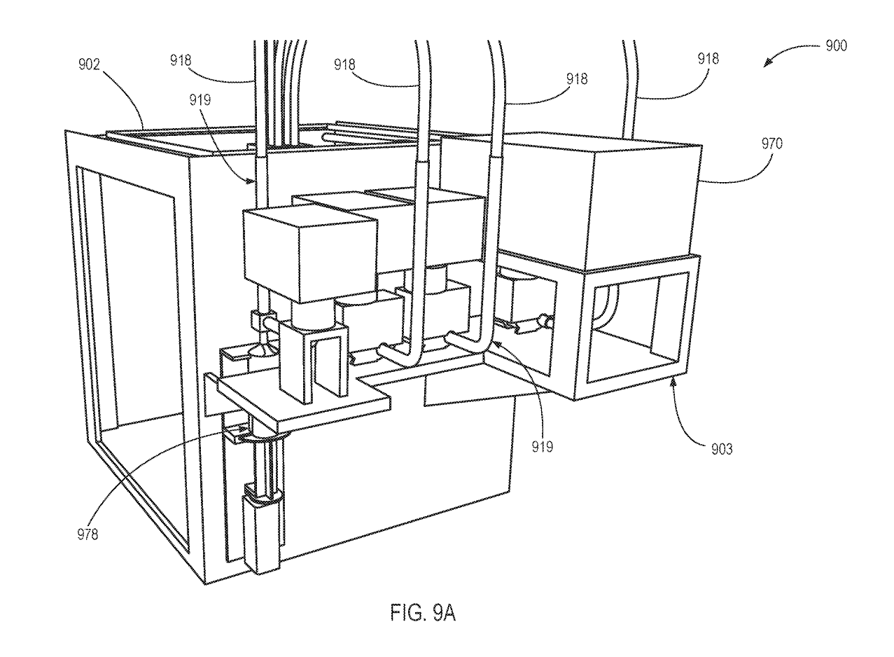

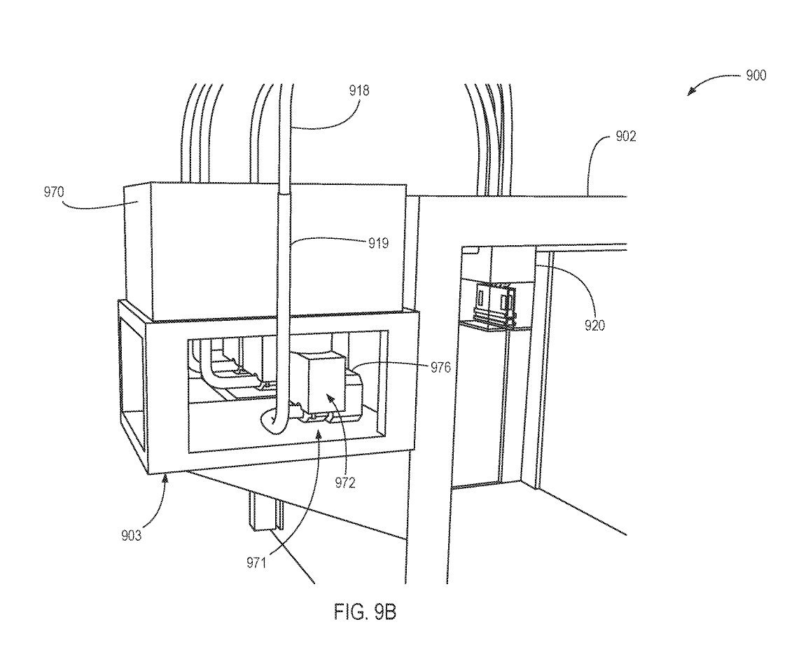

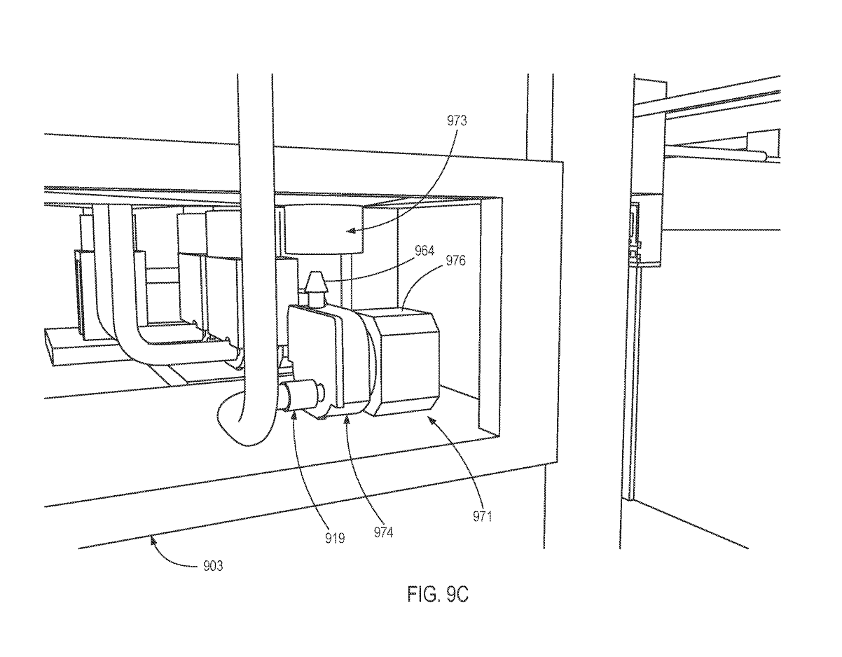

FIGS. 9A-9C are various perspective views of a printing system 900 with several storage containers 970, according to one embodiment of the present disclosure. A storage container 970 of the printing system 900 may include a container body, a storage space, and/or a pumping system 971. Some embodiments of a storage container 970 may be exclusively configured to contain a source material. Similarly, certain embodiments of a storage container 970 may be exclusively configured to contain a light-curable catalyst. Still other embodiments of a storage container 970 may be configured to store either a source material or a light-sensitive curing catalyst. A storage container 970 of the printing system 900 may be configured to be in fluid communication with a print head 920 and may be configured to communicate source material and/or light-sensitive curing catalyst to the print head 920 and/or to one or more mixing chambers of the printing system 900.

A body of a storage container 970 may be configured to define one or more components of the storage container 970. For example, a storage container body may be configured to define a storage space/cavity in which a source material or light-curable catalyst may be stored. As can be appreciated, a storage container body may be made of any sufficiently rigid and nonporous material. A material which is sufficiently rigid may cause a storage container body to retain a determined shape, and may enable a storage container 970 to withstand common pressures and/or forces which may be applied to the body of the storage container 970, without substantial damage and/or deformation of the storage container body. A sufficiently nonporous material may enable the storage container body, or a space defined by the container body, to contain various kinds of liquids without undesired leakage of the liquid material. As can be appreciated, the storage container 970 may include several spaces, lumens, and/or apertures within the container body. A sufficiently nonporous material for a storage container body may enable the storage container 970 to house and/or communicate liquids in any of the spaces, lumens, and/or apertures disposed in the container body without undesirable leakage of the contained and/or communicated liquid. In some embodiments, a storage container 970 may be made of a plastic and/or polymer material. For example, a storage container body may be made of glass, metal, PLA, nylon, polyethylene terephthalate (PET).

The storage space formed by the container body may include a determined liquid storage volume to contain a determined volume of source material and/or light-sensitive curing catalyst. The storage space may be shaped to facilitate flow of the liquid contents toward an output port 973 of the storage container 970. For example, the storage space may include a rounded, a beveled, and/or a truncated shape with an output port 973 disposed in the bottom of the storage space to facilitate flow of the liquid contents toward the output port 973. In other embodiments, the output port 973 may include a tube, configured to extend toward the bottom of the liquid storage space, to cause the end of the tube to be disposed adjacent to a bottom surface of the storage space. Thus, as liquid is pumped from the storage container 970, the output port 973 may remain in contact with any liquid remaining in the storage space. Venting ports may be incorporated to allow air to enter without spilling the contents of the storage container. As can be appreciated, a storage container 970 may utilize any suitable shape or configuration of the storage space, to facilitate flow of the liquid contents toward one or more output ports 973.

Certain embodiments of the printing system may include several storage containers configured to store source material, and may include one or more storage containers configured to contain light-sensitive curing catalyst. The source material contained in each of the source material storage containers may vary between containers, or may be similar between containers. In some embodiments, each source material storage container may be configured to house a source material which may include a specific physical property when cured. The physical properties associated with each of the source materials may be different between source materials. For example, an embodiment may include three source material storage containers, each containing a different source material. The first source material storage container may contain a source material with a specific color when cured. The second storage container may contain a source material with a determine rigidity when cured. The third storage container may contain a source material with a particular opacity. As can be appreciated, a varying number of storage containers and/or source materials stored in one or more source material storage containers may be considered.

The printing system 900 may be configured to utilize the one or more storage containers 970 to produce three-dimensional objects possessing varying physical qualities. The printing system 900 may be configured to mix the various source materials stored in each of the source material storage containers 970, to produce an object possessing one or more physical properties associated with each source material used to produce the three-dimensional object. The physical properties present in the object may be based upon which source materials are used to produce the object, and may also be based upon how much of each source material was used to produce the object. Thus, the final three-dimensional object may include varying physical properties similar to, or comprised of, one or more physical properties associated with one or more of the source materials stored in the source material storage containers 970.

As mentioned previously, a storage container 970 may include, and/or may be configured to couple with, a pumping system 971. A pumping system 971 may include one or more wet pump components, and may include dry pump components. The wet pump components of a pumping system 971 may include a pump 974, a storage container lid 972, one or more pump ports 964, and liquid tubing 918. The pump 974 may enable a storage container 970 to pump a liquid from a storage space of a storage container 970 to tubing 918 coupled with the storage container 970 and/or storage container pump 974. The wet components of a pumping system 971 may be configured individually and/or collectively to come in direct contact with one or more liquid materials of the printing system 900. For example, the wet components of the pumping system 971 may be configured to direct and/or communicate one or more liquid source materials, light-sensitive curing catalysts, and/or a light-curable mixture to any suitable component of the printing system 900. One or more of the wet components may be configured to facilitate replacement of one or more wet components of the pumping system 971, in the case of clogging of one or more wet components of the pumping system 971. The wet components may be composed of various suitably nonporous materials to facilitate communication of the various liquid materials of the printing system 900.

The storage container lid 972 may be configured to be secured to a storage container output port 973 and may facilitate fluid communication between the output port 973 and one or more pump ports 964 of the pump 974. In some embodiments, the storage container lid 972 may be configured to screw onto a storage container 970 via threads disposed adjacent to the output port 973 of the storage container 970. In other embodiments, the storage container lid 972 may be configured to be secured to a storage container 970 according to a “snap on” configuration, or according to any other suitable manner of securing the storage container lid 972. In some embodiments, the storage container lid 972 may include one or more O-rings, gaskets, threading, levers, and/or suitable locking mechanisms to secure a seal between the lid 972 of a storage container 970 and the pump 974 and/or the pump port 964.

One or more pump ports 964 of an embodiment may be configured to couple with the lid 972 of a storage container 970. The pump port 964 coupled with the storage container lid 972 may create, and/or utilize, a secure, or substantially airtight, seal between the storage container lid 972 and the pump 974 coupled with the pump port 964. The pump port 964 may be shaped or otherwise configured to receive or couple with a specific storage container lid 972. The pump port 964 may include one or more pump port apertures and/or pump port lumens, to place a storage container 970 coupled with the pump port 964 in fluid communication with the corresponding pump 974. The liquid tubing 918 may couple with a tubing coupler 919 in turn coupled with the output of the pump 974 where the tubing 918 may couple at an opposite end with the print head 920 of the printing system 900. The storage container 970 may be in fluid communication with a print head 920 of the printing system 900 when the output port 973 of the storage container 970 is coupled with the print head 920 via source material tubing. In some embodiments, the source material tubing may be fixedly coupled with the output port 973 of the storage container 970. For example, the tubing may be bonded with the output port of the storage container, and may come pre-attached.

The dry, or non-wet, components of the pumping system 971 may include a motor 976 and any suitable motor coupling system. The motor 976 of a storage container 970 may be configured to couple with the pump 974 of the storage container 970, and may provide mechanical power to the pump 974, or may otherwise enable liquid pumping of material housed in the storage container 970 via the pumping system 971. The storage container motor 976 may couple with the pump 974 to enable mechanical control of the pump 974 and any suitable pump components. The motor 976 may be configured to enable operation of the pump 974 without coming in direct contact with one or more liquid materials communicated by the various wet components of the pumping system 971. Thus, when the pump 974 is replaced the replacement pump 974 may be configured to couple with the motor 976, such that the motor 976 need not be replaced with the pump 974. As can be appreciated, the storage container motor 976 may include any suitable device to enable operation of the pump 974. For example, the motor 976 may include a linear actuator, a durable stepper motor, a syringe 978, or any other suitable source of mechanical power.

For example, an embodiment may include a syringe pump to facilitate operation of the system embodiment. The syringe pump may include non-wet components, such as a durable linear actuator (which may act in place of a durable stepper motor described previously), and a rigid bracket to hold the components of the syringe pump (e.g., the linear actuator and the body of the pump) in place. The syringe pump may also include a plurality of wet and possibly disposable components, designed to come in physical contact with one or more liquid materials of the system. The wet components may include an actual syringe or syringe pump body, an automatic or controllable flow valve, and tubing to fluidly couple the syringe pump with at least one storage container and the print head of the system embodiment. The syringe pump body may include a lumen with a plunger configured to travel vertically within the lumen to control a flow of fluid into and out of the syringe. The automatic valve may control the fluid flow of liquid material flowing into and out of the syringe pump. For example, the automatic valve may cause a liquid material to flow from a storage container into the syringe lumen, via tubing coupling the syringe and the storage container, when the syringe plunger is retracted by the durable actuator coupled to the plunger. While liquid material flows into the syringe pump from a storage container, the automatic valve may operate to substantially prevent any liquid material disposed in the tubing coupling the syringe pump to the print head from flowing back into the lumen of the syringe pump. Further, the actuator may cause the plunger to advance within the syringe lumen to cause liquid material disposed within the lumen to flow into the print head via the corresponding tubing, and may be prevented from flowing back into a storage container by the automatic valve.

The motor 976 may couple with the pump 974, which may be configured to couple with the lid 972 and output port 973, of a storage container 970. In some embodiments, a storage container 970 may be easily and/or automatically coupled with the pumping system 971 by one or more components designed to receive the storage container 970. For example, the printing system 900 may be configured to enable and/or facilitate a “snap in” configuration of a storage container 970, in which a storage container 970 may automatically couple with the printer housing 902 and/or pumping system 971 when the storage container 970 is placed in the storage container bracket 903 formed by the printer housing 902.

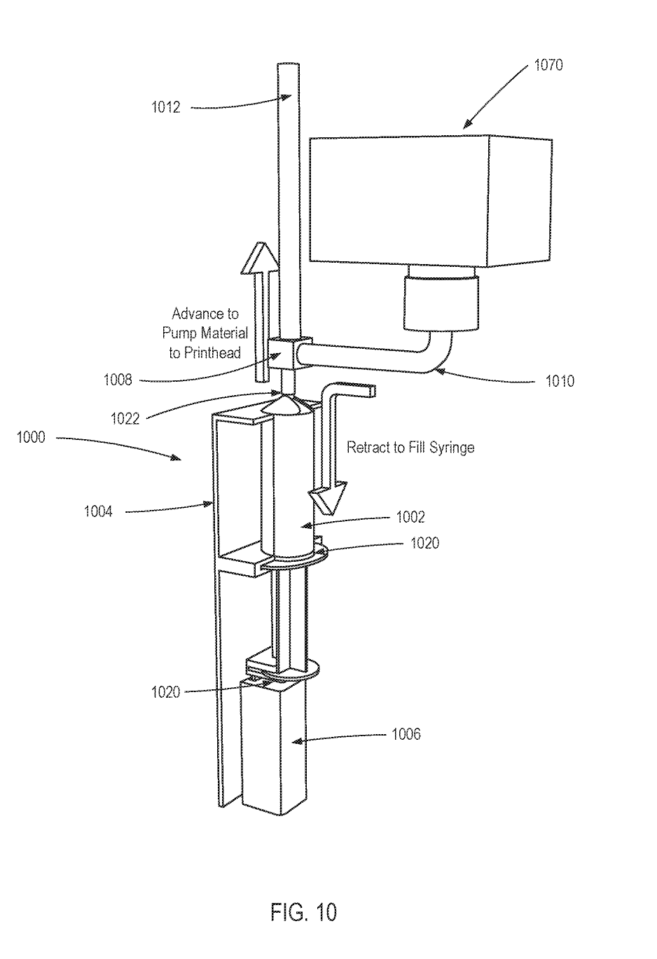

For improved quality of print, one or more pressure sensors and/or flow sensors can be optionally added to the pump 974, to provide feedback to the pump motor 976 for improved accuracy, as described below with reference to FIG. 10.

FIG. 10 is a perspective view of a syringe pump 1000 according to one embodiment. The syringe pump 1000 includes a syringe 1002, one or more brackets 1004 to secure the syringe 1002 and/or other pump components, a linear actuator 1006, and an automatic valve 1008. The linear actuator 1006 drives the syringe 1002. An inflow line 1010 may be tubing that couples a storage container 1070 to the automatic valve 1008 and the syringe 1002. The linear actuator 1006 retracts the syringe 1002 to fill the syringe barrel with material from the storage container 1070. The automatic valve 1008 allows material to pass from the inflow line 1010 into the syringe barrel. The linear actuator 1006 also advances the syringe 1002 by applying pressure to the syringe plunger to push material in the syringe barrel into an outflow line 1012. The automatic valve 1008 is operable to direct the material to flow into the outflow line 1012 and prevents the material from backflowing into the inflow line 1010. The material is pushed through the outflow line 1012 to a print head, where the material is mixed and extruded to form an object being printed.

For improved quality of print, one or more pressure sensors 1020 can be optionally added to the pump 1000. For example, a pressure-sensor 1020 may be coupled to or otherwise utilized with the syringe plunger or the syringe barrel. A flow sensor 1022 (or current sensor) may be utilized on the syringe 1002 to approximate (or as a surrogate for) pump pressure. Pressure sensing can be a surrogate for flow sensing and allows for feedback to the linear actuator 1006 to improve accuracy of the quantity of delivered resin. A flow sensor can optionally be added in line with the tubing. For example, a flow sensor 1022 and/or pressure sensor may be utilized in or on the tubing 1012 that moves material to the print head. This allows for feedback to the pump actuator to directly improve the accuracy of the quantity of the delivered resin.

FIGS. 11A-11D depict a method of producing a three-dimensional object, according to one embodiment, using delayed curing (or delayed setting). Delayed curing is currently only possible with extrusion of light-cured resins. Producing three-dimension objects with disclosed embodiments using delayed curing allows significant improvements in transparent printing. FIG. 11A illustrates a completed core portion 1102 of a transparent object 1100 printed using water-clear resin in a three-dimensional printing process and/or system according to the present disclosure, in which curing light is applied to the resin immediately upon extrusion. FIG. 11B illustrates an outer wall 1104 that have been printed by layers around the core portion 1102 using the water-clear resin and applying curing light immediately after extrusion. FIG. 11C illustrates water-clear resin being flowed into space(s) 1106 between the outer wall 1104 and the core portion 1102. The water-clear resin is allowed to flow into the space(s) 1106 with curing lights turned off, completely filling the space(s) 1106 and eliminating any voids caused by immediate application of curing light to the extruded material of the core portion 1102 and/or the outer wall 1104. After the uncured′ water-clear resin is fully flowed into the space(s) 1106 between the outer wall 1104 and the core portion 1102, this resin is cured by enabling the curing lights and passing them over the area. A result of this process is a three-dimensional object of excellent transparency

FIG. 12 illustrates an object 1200 printed using standard fused filament three-dimensional printing techniques. Standard fused filament three-dimensional printing techniques leave small voids 1203 and interfaces between filaments resulting in internal reflection and refraction, and ultimately lack of true transparency.

The foregoing specification has been described with reference to various embodiments, including the best mode. However, those skilled in the art appreciate that various modifications and changes can be made without departing from the scope of the present disclosure and the underlying principles of the invention. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

As used herein, the terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof are intended to cover a physical connection, an electrical connection, a magnetic connection, an optical connection, a communicative connection, a functional connection, and/or any other connection.

In some cases, well-known features, structures, or operations are not shown or described in detail. Furthermore, the described features, structures, or operations may be combined in any suitable manner in one or more embodiments. It will also be readily understood that the components of the embodiments as generally described and illustrated in the figures herein could be arranged and designed in a wide variety of different configurations.

Various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

While the principles of this disclosure have been shown in various embodiments, many modifications of structure, arrangements, proportions, elements, materials, and components, used in practice, which are particularly adapted for a specific environment and operating requirements, may be used without departing from the principles and scope of this disclosure. These and other changes or modifications are intended to be included within the scope of the present disclosure.

1. A print head for a printing system for producing three-dimensional objects from liquid resins, the print head configured to receive, mix, and extrude a light-curable mixture to print in three dimensions, the print head comprising:
a mixing chamber including input ports to receive liquid resin source material and a light-sensitive curing catalyst and an output port to output a light-curable mixture, the mixing chamber configured to mix liquid resin source material and a light-curable catalyst to form a light-curable mixture;
a nozzle to receive and extrude the light-curable material to a three-dimensional object being produced by the printing system; and
a light source disposed on an exterior of the movable print head adjacent the nozzle of the print head, the light source to radiate light on the light-curable mixture upon extrusion of the light-curable mixture from the nozzle.

2. The print head of claim 1, wherein the mixing chamber includes an input port to receive one or more additional source materials in addition to the liquid resin source material and the light-sensitive curing catalyst, and wherein the mixing chamber is configured to mix the one or more additional source materials into the light-curable mixture.

3. The print head of claim 2, wherein the one or more additional source materials include one or more of:
a coloring;
a conductive material;
a chemical to adjust a boiling point of liquid resin source material following curing;
opacity material; and
a second liquid resin source material having properties different from the liquid resin source material.

4. The print head of claim 1, wherein the mixing chamber is detachable from the print head to allow replacement with a new mixing chamber.

5. The print head of claim 1, wherein the mixing chamber is disposed within the nozzle.

6. The print head of claim 1, wherein the nozzle is detachable from the print head to allow replacement with a new nozzle.

7. The print head of claim 1, wherein the light source includes an array of one or more light emitting diodes.

8. The print head of claim 1, wherein the light source includes one or more lasers.

9. A printing system for producing three-dimensional objects from liquid resins, the system comprising:
a movable print head configured to receive, mix, and extrude a light-curable mixture including liquid resin source material and a light-sensitive curing catalyst to print in three dimensions, the print head comprising:
a mixing chamber including input ports to receive liquid resin source material and a light-sensitive curing catalyst and an output port to output a light-curable mixture, the mixing chamber configured to mix the liquid resin source material and the light-sensitive curing catalyst to form a light-curable mixture;
a nozzle to receive and extrude the light-curable material to a three-dimensional object being produced by the printing system; and
a light source disposed on an exterior of the movable print head adjacent the nozzle of the print head, the light source to radiate light on the light-curable mixture as it is extruded from the nozzle;
a source material storage container to store a volume of liquid resin source material that maintains a liquid state at room temperature;
a source material wet pump configured to pump liquid resin source material from the source material storage container;
source tubing that couples the source material wet pump to an input port of the mixing chamber of the print head, in fluid communication;
a catalyst storage container configured to store a volume of liquid light-sensitive curing catalyst to be mixed with the liquid resin source material and catalyze curing of the liquid resin source material upon exposure to light;
a catalyst wet pump configured to communicate a light-sensitive curing catalyst from the catalyst storage container to a mixing chamber; and
catalyst tubing coupling the catalyst wet pump to an input port of the mixing chamber of the print head, in fluid communication.

10. The printing system of claim 9, wherein the mixing chamber of the movable print head includes an input port to receive one or more additional source materials in addition to the liquid resin source material and the light-sensitive curing catalyst, and wherein the mixing chamber is configured to mix the one or more additional source materials into the light-curable mixture.

11. The printing system of claim 10, wherein the one or more additional source materials include one or more of:
a coloring;
a conductive material;
a chemical to adjust a boiling point of liquid resin source material following curing;
opacity material; and
a second liquid resin source material having properties different from the liquid resin source material.

12. The printing system of claim 9, wherein the mixing chamber is detachable from the print head to allow replacement with a new mixing chamber, in the event of clogging of the mixing chamber.

13. The printing system of claim 9, wherein the nozzle is detachable from the print head to allow replacement with a new nozzle, in the event of clogging of the nozzle.

14. The printing system of claim 13, wherein a second mixing chamber is disposed in the nozzle, the second mixing chamber configured to be in fluid communication with at least one input port and configured to be in fluid communication with the first mixing chamber.

15. The printing system of claim 9, wherein the light source includes an array of one or more light emitting diodes.

16. The printing system of claim 9, wherein the light source includes one or more lasers.

17. A method of producing a three-dimensional object, comprising:
providing a liquid resin source material that maintains a liquid state at room temperature to an input port of a movable print head;
providing a liquid light-sensitive curing catalyst to a second input port of the print head;
mixing the liquid light-sensitive curing catalyst with the liquid resin source material within a mixing chamber of the print head to produce a light-curable mixture;
extruding from a nozzle of the print head the light-curable mixture to a three-dimensional object being produced; and
radiating light on the light curable mixture, as it is extruded from the nozzle to the three-dimensional object, the radiating from a light source disposed on an exterior of the movable print head adjacent the nozzle of the print head.

18. The method of claim 17, wherein providing the liquid light-sensitive curing catalyst to a second input port comprises varying a quantity of the liquid light-sensitive curing catalyst to vary on or more physical properties of a portion of material of the three-dimensional object.

19. The method of claim 17, wherein providing the liquid light-sensitive curing catalyst to a second input port comprises continuously varying a quantity of the liquid light-sensitive curing catalyst during the extruding from the nozzle a layer of-light curable mixture to continuously vary one or more physical properties of a layer of material of the three-dimensional object.

20. The method of claim 17, further comprising providing to a third input port of the movable print head one or more additional source materials in addition to the liquid resin source material and the light-sensitive curing catalyst;
mixing, within the mixing chamber, the one or more additional source materials into the light-curable mixture to vary one or more physical properties of a portion of material of the three-dimensional object.
